(19) United States
(12) Patent Application Publication
(10) Pub. No.: US 2012/0212405 A1
(43) Pub. Date: Aug. 23, 2012

(54) SYSTEM AND METHOD FOR PRESENTING VIRTUAL AND AUGMENTED REALITY SCENES TO A USER

(76) Inventors: BENJAMIN ZEIS NEWHOUSE, SAN FRANCISCO, CA (US); TERRENCE EDWARD MCARDLE, SAN FRANCISCO, CA (US)

(21) Appl. No.: 13/302,986

(22) Filed: Nov. 22, 2011

Related U.S. Application Data
(63) Continuation-in-part of application No. 13/269,231, filed on Oct. 7, 2011.
(60) Provisional application No. 61/417,198, filed on Nov. 24, 2010.
(60) Provisional application No. 61/417,202, filed on Nov. 24, 2010.
(60) Provisional application No. 61/448,130, filed on Mar. 1, 2011.
(60) Provisional application No. 61/448,136, filed on Mar. 1, 2011.
(60) Provisional application No. 61/390,975, filed on Oct. 7, 2010.
(60) Provisional application No. 61/448,128, filed on Mar. 1, 2011.

(51) Int. Cl. G09G 5/00

(52) U.S. Cl. 345/156; 345/633

(57) ABSTRACT

A method according to a preferred embodiment can include providing an embeddable interface for a virtual or augmented reality scene, determining a real orientation of a viewer representative of a viewing orientation relative to a projection matrix, and determining a user orientation of a viewer representative of a viewing orientation relative to a nodal point. The method of the preferred embodiment can further include orienting the scene within the embeddable interface and displaying the scene within the embeddable interface on a device.

### CLAIM OF PRIORITY

The present application claims priority to: U.S. Provisional Patent Application Ser. No. 61/417,198 filed on 24 Nov. 2010, entitled “Method for Mapping Virtual and Augmented Reality Scenes to a Display,” U.S. Provisional Patent Application Ser. No. 61/417,202 filed on 24 Nov. 2010, entitled “Method for Embedding a Scene of Orientation Aware Spatial Imagery in a Webpage;” U.S. Provisional Patent Application Ser. No. 61/448,130 filed on 1 Mar. 2011, entitled “For Mapping Virtual and Augmented Reality Scenes to a Display,” U.S. Provisional Patent Application Ser. No. 61/448,136 filed on 1 Mar. 2011, entitled “Method for Embedding a Scene of Orientation Aware Spatial Imagery in a Webpage,” all of which are incorporated herein in their entirety by this reference. The present application is a continuation-in-part of U.S. patent application Ser. No. 13/269,231 filed on 7 Oct. 2011, entitled “System and Method for Transitioning Between Interface Modes in Virtual and Augmented Reality Applications,” which claims priority to the following: U.S. Provisional Patent Application Ser. No. 61/390,975 filed on Oct. 7, 2010 entitled “Method for Transitioning Between Interface Modes in Virtual and Augmented Reality Applications,” and U.S. Provisional Patent Application Ser. No. 61/448,128 filed on Mar. 1, 2011 entitled “Method for Transitioning Between Interface Modes in Virtual and Augmented Reality Applications,” all of which are incorporated herein in their entirety by this reference.

### TECHNICAL FIELD

This invention relates generally to the virtual and augmented reality field, and more specifically to a new and useful system and method for presenting virtual and augmented reality scenes to a user.

### BACKGROUND AND SUMMARY

There has been a rise in the availability of mobile computing devices in recent years. These devices typically include inertial measurement units, compasses, GPS transceivers, and a screen. Such capabilities have led to the development and use of augmented reality applications. However, the handheld computing device by its nature has no sensing coupled to the human viewer and thus truly immersive experiences are lost through this technical disconnect. When viewing augmented reality the perspective is relative to the mobile device and not the user. Thus, there is a need in the virtual and augmented reality field to create a new and useful system and/or method for presenting virtual and augmented reality scenes to a user.

Accordingly, one method of the preferred embodiment can include providing an embeddable interface for a virtual or augmented reality scene, determining a real orientation of a viewer representative of a viewing orientation relative to a projection matrix, and determining a user orientation of a viewer representative of a viewing orientation relative to a nodal point. The method of the preferred embodiment can further include orienting the scene within the embeddable interface and displaying the scene within the embeddable interface on a device. Other features and advantages of the method of the preferred embodiment and variations thereof are described in detail below with reference to the following drawings.

### BRIEF DESCRIPTION OF THE FIGURES

FIG. 1 is a schematic representation of an apparatus according to a preferred embodiment of the present invention.

FIGS. 2 and 3 are schematic representations of additional aspects of the apparatus according to the preferred embodiment of the present invention.

FIG. 4 is a schematic representation of an operational environment of the apparatus according to the preferred embodiment of the present invention.

FIGS. 5A, 5B, 5C, 5D, and 5E are schematic representations of additional aspects of the apparatus according to the preferred embodiment of the present invention.

FIGS. 6 and 7 are flow charts depicting a method according to a preferred embodiment of the present invention and variations thereof.

FIG. 8 is a flowchart depicting a method for presenting a virtual or augmented reality scene to a user in accordance with a preferred embodiment of the present invention.

FIG. 9 is a flowchart depicting a method for presenting a virtual or augmented reality scene to a user in accordance with a variation of the preferred embodiment of the present invention.

FIG. 10 is a flowchart depicting a method for presenting a virtual or augmented reality scene to a user in accordance with another variation of the preferred embodiment of the present invention.

FIG. 11 is a flowchart depicting a method for presenting a virtual or augmented reality scene to a user in accordance with another variation of the preferred embodiment of the present invention.

FIG. 12 is a schematic representation of a user interfacing with an apparatus of another preferred embodiment of the present invention.

FIGS. 13A, 13B, 13C, and 13D are schematic representations of one or more additional aspects of the apparatus of the preferred embodiment of the present invention.

FIGS. 14A, 14B, 14C, and 14D are schematic representations of one or more additional aspects of the apparatus of the preferred embodiment of the present invention.

FIGS. 15A, 15B, and 15C are schematic representations of one or more additional aspects of the apparatus of the preferred embodiment of the present invention.

FIGS. 16A and 16B are schematic representations of one or more additional aspects of the apparatus of the preferred embodiment of the present invention.

FIG. 17 is another schematic representation of an apparatus of the preferred embodiment of the present invention.

FIG. 18 is a flowchart depicting a method for presenting a virtual or augmented reality scene according to another preferred embodiment of the present invention.

FIG. 19 is a schematic block diagram of a variation of the apparatus of the preferred embodiment.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

1. Apparatus Having at Least Two Viewing and/or Operational Modes

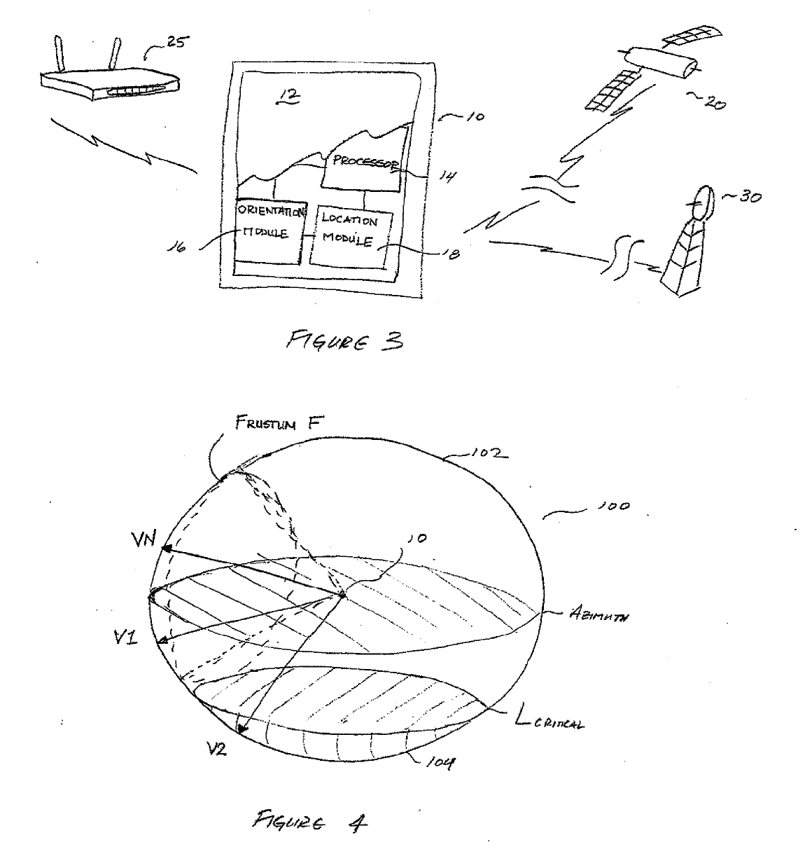

As shown in FIG. 3, an apparatus 10 of the preferred embodiment can include a user interface 12 including a display on which at least two viewing modes are visible to a user; an orientation module 16 configured to determine a three-dimensional orientation of the user interface; and a processor 14 connected to the user interface 12 and the orientation module 16 and adapted to manage a transition between the at least two viewing modes. The apparatus 10 of the preferred embodiment functions to create a seamless interface for providing a virtual-reality and/or augmented-reality viewing mode coupled to a traditional control viewing mode. Preferably, the apparatus 10 can include a device configured for processing both location-based and orientation-based data such as a smart phone or a tablet computer. The apparatus 10 also preferably includes one or more controls that are displayable and/or engagable through the user interface 12, which can be used in part to display and/or project the control/s. As described in detail below, apparatus 10 of the preferred embodiment can function as window into an augmented or mediated reality that superimposes virtual elements with reality-based elements.

Additionally, the apparatus 10 of the preferred embodiment can include an imaging system (not shown) having one or more cameras configured for performing image processing on the surrounding environment, including the user. In one variation of the apparatus 10 of the preferred embodiment, the imaging system can include a front facing camera that can be used to determine the position of the user relative to the apparatus 10. Alternatively, the apparatus 10 of the preferred embodiment can be configured to only permit a change in viewing modes in response to the user being present or within a viewing field of the imaging device. Additional sensors can include an altimeter, a distance sensor, an infrared tracking system, or any other suitable sensor configured for determining a the relative position of the apparatus 10, its environment, and its user.

As shown in FIG. 1, the apparatus 10 of the preferred embodiment can be generally handled and/or oriented in three-dimensions. Preferably, the apparatus 10 can have a directionality conveyed by arrow A such that the apparatus 10 defines a “top” and “bottom” relative to a user holding the apparatus 10. As shown, the apparatus 10 of the preferred embodiment can operate in a three-dimensional environment within which the apparatus can be rotated through three-degrees of freedom. Preferably, the apparatus 10 can be rotated about the direction of arrow A wherein the first degree of rotation is a roll value. Similarly, the apparatus 10 of the preferred embodiment can be rotated in a first direction substantially perpendicular to the arrow A wherein the second degree of rotation is a pitch value. Finally, the apparatus 10 of the preferred embodiment can be rotated in a second direction substantially mutually orthogonal to the roll and pitch plane, wherein the third degree of rotation is a yaw value. The orientation of the apparatus 10 of the preferred embodiment can be at least partially determined by a combination of its roll, pitch, and yaw values.

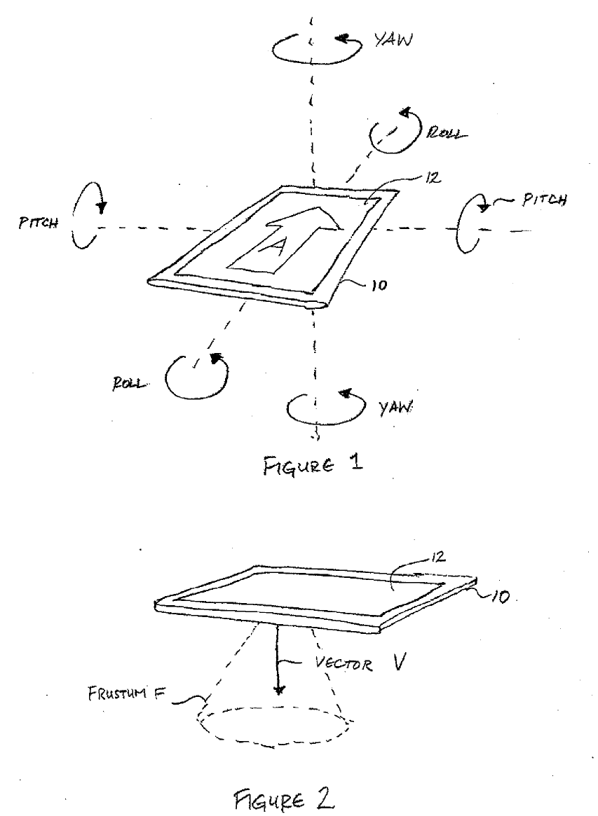

As shown in FIG. 2, the apparatus 10 of the preferred embodiment can define an imaginary vector V that projects in a predetermined direction from the apparatus 10. Preferably, the vector V originates on a side of the apparatus 10 substantially opposite the user interface 12 such that the imaginary vector V is substantially collinear with and/or parallel to a line-of-sight of the user. As an example, the imaginary vector V will effectively be “pointed” in the direction in which the user is looking, such that if the apparatus 10 includes a camera (not shown) opposite the display, then the imaginary vector V can function as a pointer on an object of interest within the view frame of the camera. In one variation of the apparatus 10 of the preferred embodiment, the imaginary vector V can be arranged along a center axis of a view frustum F (shown in phantom), the latter of which can be substantially conical in nature and include a virtual viewing field for the camera.

Preferably, the orientation of the apparatus 10 corresponds with a directionality of the imaginary vector V. Furthermore, the directionality of the imaginary vector V preferably determines which of two or more operational modes the display 12 of the apparatus 10 of the preferred embodiment presents the user. Accordingly, the apparatus 10 of the preferred embodiment preferably presents a first viewing mode, a second viewing mode, and an optional transitional or hybrid viewing mode between the first and second viewing modes in response to a directionality of the imaginary vector V. Preferably, the first viewing mode can include a virtual and/or augmented reality display superimposed on reality-based information, and the second viewing mode can include a control interface through which the user can cause the apparatus 10 to perform one or more desired functions.

As shown in FIG. 3, the orientation module 16 of the apparatus 10 of the preferred embodiment functions to determine a three-dimensional orientation of the user interface 12. As noted above, the three-dimensional orientation can include a roll value, a pitch value, and a yaw value of the apparatus 10. Alternatively, the three dimensional orientation can include an imaginary vector V originating at the apparatus and intersecting a surface of an imaginary sphere disposed about the apparatus, as shown in FIG. 4. In another alternative, the three-dimensional orientation can include some combination of two or more of the roll value, pitch value, yaw value, and/or the imaginary vector V, depending upon the physical layout and configuration of the apparatus 10.

The processor 14 of the apparatus 10 of the preferred embodiment functions to manage a transition between the viewing modes in response to a change in the orientation of the apparatus 10. In particular, the processor 14 preferably functions to adjust, change, and/or transition displayable material to a user in response to a change in the orientation of the apparatus 10. Preferably, the processor 14 can manage the transition between the viewing modes in response to the imaginary vector/s V1, V2, VN (and accompanying frustum F) intersecting the imaginary sphere at a first latitudinal point having a predetermined relationship to a critical latitude (L_{CRITICAL}) of the sphere. As shown in FIG. 4, the critical latitude can be below an equatorial latitude, also referred to as the azimuth or a reference plane. The critical latitude can be any other suitable location along the infinite latitudes of the sphere, but in general the position of critical latitude will be determined at least in part by the relative positioning of the imaginary vector V and the user interface 12. In the exemplary configuration shown in FIGS. 1, 2, 3 and 4, the imaginary vector V emanates opposite the user interface 12 such that a transition between the two or more viewing modes will occur when the apparatus is moved between a substantially flat position and a substantially vertical position.

As shown in FIG. 3, one variation of the apparatus 10 of the preferred embodiment includes a location module 18 connected to the processor 14 and the orientation module 16. The location module 18 of the preferred embodiment functions to determine a location of the apparatus 10. As used herein, location can refer to a geographic location, which can be indoors, outdoors, above ground, below ground, in the air or on board an aircraft or other vehicle. Preferably, as shown in FIG. 4, the apparatus 10 of the preferred embodiment can be connectable, either through wired or wireless means, to one or more of a satellite positioning system 20, a local area network or wide area network such as a WiFi network 25, and/or a cellular communication network 30. A suitable satellite position system 20 can include for example the Global Positioning System (GPS) constellation of satellites, Galileo, GLONASS, or any other suitable territorial or national satellite positioning system. In one alternative embodiment, the location module 18 of the preferred embodiment can include a GPS transceiver, although any other type of transceiver for satellite-based location services can be employed in lieu of or in addition to a GPS transceiver.

In another variation of the apparatus 10 of the preferred embodiment, the orientation module 16 can include an inertial measurement unit (IMU). The IMU of the preferred orientation module 16 can include one or more of a MEMS gyroscope, a three-axis magnetometer, a three-axis accelerometer, or a three-axis gyroscope in any suitable configuration or combination. Alternatively, the IMU can include one or more of one or more single-axis and/or double-axis sensors of the type noted above in a suitable combination for rendering three-dimensional positional information. Preferably, the IMU includes a suitable combination of sensors to determine a roll value, a pitch value, and a yaw value as shown in FIG. 1. As previously noted, any possible combination of a roll value, a pitch value, and a yaw value in combination with a directionality of the apparatus 10 corresponds to a unique imaginary vector V, from which the processor 14 can determine an appropriate viewing mode to present to the user. Alternatively, the IMU can preferably include a suitable combination of sensors to generate a non-transitory signal indicative of a rotation matrix descriptive of the three-dimensional orientation of the apparatus 10.

In another variation of the apparatus 10 of the preferred embodiment, the viewing modes can include a control mode and a reality mode. The control mode of the apparatus 10 of the preferred embodiment functions to permit a user to control one or more functions of the apparatus 10 through or with the assistance of the user interface. As an example, if the apparatus 10 is a tablet computer or other mobile handheld device, the control module can include one or more switches, controls, keyboards and the like for controlling one or more aspects or functions of the apparatus 10. Alternatively, the control mode of the apparatus in of the preferred embodiment can include a standard interface, such as a browser, for presenting information to a user. In one example embodiment, a user can “select” a real object in a reality mode (for example a hotel) and then transition to the control mode in which the user might be directed to the hotel's webpage or other webpages relating to the hotel.

The reality mode of the apparatus 10 of the preferred embodiment functions to present to the user one or more renditions of a real space, which can include for example: a photographic image of real space corresponding to an imaginary vector and/or frustum as shown in FIG. 4; modeled images of real space corresponding to the imaginary vector and/or frustum shown in FIG. 4; simulated images of real space corresponding to the imaginary vector and/or frustum as shown in FIG. 4, or any suitable combination thereof. Preferably, real space images can be received and/or processed by a camera connected to or integral with the apparatus 10 and oriented in the direction of the imaginary vector and/or frustum shown in FIG. 2.

The reality mode of the apparatus 10 of the preferred embodiment can include one or both of a virtual reality mode or an augmented reality mode. A virtual reality mode of the apparatus 10 of the preferred embodiment can include one or more models or simulations of real space that are based on—but not photographic replicas of—the real space at which the apparatus 10 is directed. The augmented reality mode of the apparatus 10 of the preferred embodiment can include either a virtual image or a real image of the real space augmented by additional superimposed and computer-generated interactive media, such as additional images of a particular aspect of the image, hyperlinks, coupons, narratives, reviews, additional images and/or views of an aspect of the image, or any suitable combination thereof. Preferably, the virtual and augmented reality view can be rendered through any suitable platform such as OpenGL, WebGL, or Direct3D. In one variation, HTML 5 and CSS3 transforms are used to render the virtual and augmented reality view where the device orientation is fetched (e.g., through HTML5 or a device API) and used to periodically update (e.g., 60 frames per second) the CSS transform properties of media of the virtual and augmented reality view.

In another variation of the apparatus 10 of the preferred embodiment, the critical latitude corresponds to a predetermined pitch range, a predetermined yaw range, and a predetermined roll range. As noted above, the pitch value, yaw value, and roll value are all preferably measurable by the orientation module 16 of the apparatus 10 of the preferred embodiment. Accordingly, upon a determination that a predetermined pitch range, predetermined yaw range, and/or a predetermined roll range is satisfied, the processor 14 preferably causes the transition between the at least two viewing modes. As shown in FIG. 4, the critical latitude is substantially planar in form and is oriented substantially parallel to the azimuth. In other alternative embodiments, the critical latitude can be non-planar in shape (i.e., convex or concave) and oriented at acute or obtuse angle relative to the azimuth.

In another variation of the apparatus 10 of the preferred embodiment, the predetermined pitch range is more than approximately forty-five degrees below the azimuth. As shown in FIG. 4, imaginary vector V1 has a pitch angle of less than forty-five degrees below the azimuth, while imaginary vector V2 has a pitch angle of more than forty-five degrees below the azimuth. As shown, imaginary vector V1 intersects the surface of the sphere 100 in a first portion 102, which is above the critical latitude, and imaginary vector V2 intersects the sphere 100 in a second portion 104 below the critical latitude. Preferably, the different portions 102, 104 of the sphere 100 correspond to the one or more viewing modes of the apparatus 10. Preferably, the predetermined pitch range is such that the orientation of the apparatus 10 will be more horizontally disposed than vertically disposed (relative to the azimuth), such that an example pitch angle of ninety degrees corresponds to a user laying the apparatus 10 flat on a table and a pitch angle of zero degrees corresponds to the user holding the apparatus 10 flat against a vertical wall.

In another variation of the apparatus 10 of the preferred embodiment, the predetermined yaw range is between zero and one hundred eighty degrees about an imaginary line substantially perpendicular to the imaginary vector V. As shown in FIG. 1, the apparatus 10 of the preferred embodiment can have a desirable orientation along arrow A, which comports with the apparatus 10 having a “top” and “bottom” a user just as a photograph or document would have a “top” and “bottom.” The direction of the arrow A shown in FIG. 1 can be measured as a yaw angle as shown in FIG. 1. Accordingly, in this variation of the apparatus 10 of the preferred embodiment, the “top” and “bottom” of the apparatus 10 can be rotatable and/or interchangeable such that in response to a rotation of approximately one hundred eighty degrees of yaw, the “top” and “bottom” can rotate to maintain an appropriate viewing angle for the user. In another alternative, the predetermined yaw value range can be between zero and approximately M degrees, wherein M degrees is approximately equal to three hundred sixty degrees divided by the number of sides S of the user interface. Thus, when S equals four sides, the predetermined yaw value range can be between zero and ninety degrees. Similarly, when S equals six sides, the predetermined yaw value range can be between zero and sixty degrees. Finally, for a substantially circular user interface, the view of the user interface can rotate with the increase/decrease in yaw value in real time or near real time to maintain the desired viewing orientation for the user.

In another variation of the apparatus 10 of the preferred embodiment, the predetermined roll range is more than approximately forty-five degrees below the azimuth. As shown in FIG. 4, imaginary vector V1 has a roll angle of less than forty-five degrees below the azimuth, while imaginary vector V2 has a roll angle of more than forty-five degrees below the azimuth. As previously noted, imaginary vector V1 intersects the surface of the sphere 100 in the first portion 102 and imaginary vector V2 intersects the sphere 100 in a second portion 104. Preferably, the different portions 102, 104 of the sphere 100 correspond to the one or more viewing modes of the apparatus 10. Preferably, the predetermined roll range is such that the orientation of the apparatus 10 will be more horizontally disposed than vertically disposed (relative to the azimuth), such that an example roll angle of ninety degrees corresponds to a user laying the apparatus 10 flat on a table and a roll angle of zero degrees corresponds to the user holding the apparatus 10 flat against a vertical wall.

In another variation of the apparatus 10 of the preferred embodiment, substantially identical constraints apply to the pitch value and the roll value. In the example embodiment shown in the FIGURES, the apparatus 10 can be configured as a substantially rectangular device having a user interface 12 that also functions as a display. The apparatus 10 of the preferred embodiment can be configured such that it is substantially agnostic to the pitch and/or roll values providing that the yaw value described above permits rotation of the user interface 12 in a rectangular manner, i.e., every ninety degrees.

In additional variations of the apparatus 10 of the preferred embodiment, the apparatus can employ any suitable measuring system and coordinate system for determining a relative orientation of the apparatus 10 in three dimensions. As noted above, the IMU of the apparatus 10 of the preferred embodiment can include any suitable sensor configured to produce a rotation matrix descriptive of the orientation of the apparatus 10. Preferably, the orientation of the apparatus 10 can be calculated as a point on an imaginary unit sphere (co-spherical with the imaginary sphere shown in FIG. 4) in Cartesian or any other suitable coordinates. Alternatively, the orientation of the apparatus can be calculated as an angular rotation about the imaginary vector to the point on the imaginary unit sphere. As an example, a pitch angle of negative forty-five degrees corresponds to a declination along the z-axis in a Cartesian system. In particular, a negative forty-five degree pitch angle corresponds to a z value of approximately 0.707, which is approximately the sine of forty-five degrees or one half the square root of two. Accordingly, the orientation of the apparatus 10 of the preferred embodiment can also be calculated, computed, determined, and/or presented more than one type of coordinates and in more than one type of coordinate system. Those of skill in the art will readily appreciate that operation and function of the apparatus 10 of the preferred embodiment is not limited to either Euler coordinates or Cartesian coordinates, nor to any particular combination or sub-combination of orientation sensors. Those of skill in the art will additionally recognize that one or more frames of reference for each of the suitable coordinate systems are readily usable, including for example at least an apparatus frame of reference and an external (real world) frame of reference).

2A. Method for Transitioning a User Interface Between Two operational Modes

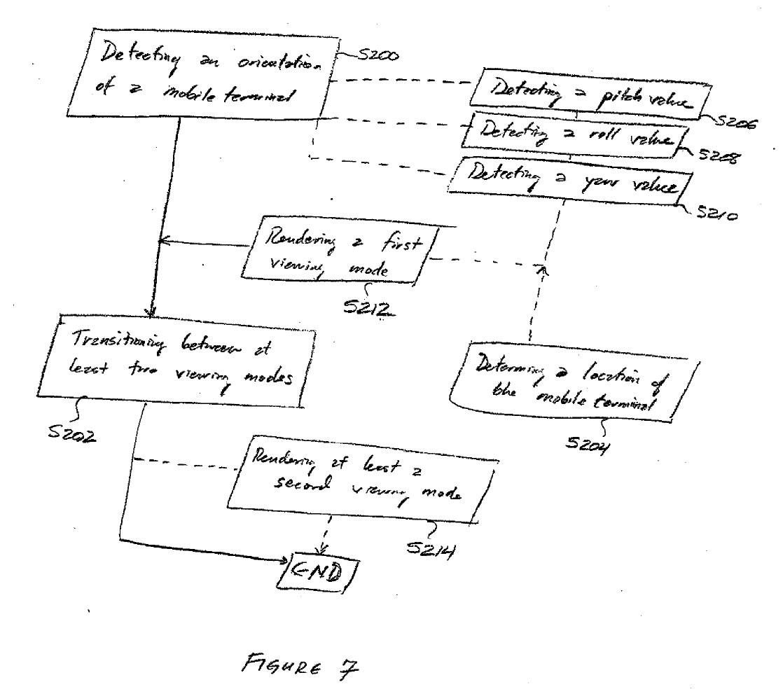

As shown in FIG. 6, a method for transitioning a user interface between two viewing modes includes detecting an orientation of a user interface in block S100; rendering a first view in the user interface in block S102; and rendering a second view in the user interface in block S104. The method of the preferred embodiment functions to cause a user interface, preferably including a display, to transition between at least two viewing modes. Preferably, as described below, the at least two viewing modes can include a reality mode (including for example a virtual and/or augmented reality view) and a control mode.

Block S100 of the method of the preferred embodiment recites detecting an orientation of a user interface. Block S100 functions to detect, infer, determine, and or calculate a position of a user interface (which can be part of a larger apparatus) in three-dimensional space such that a substantially precise determination of the position of the user interface relative to objects in real space can be calculated and/or determined. Preferably, the orientation of the user interface can include an imaginary vector originating at the user interface and intersecting a surface of an imaginary sphere disposed about the user interface as shown in FIG. 4 and described above. The imaginary vector can preferably function as a proxy measurement or shorthand measurement of one or more other physical measurements of the user interface in three-dimensional space.

Block S102 of the method of the preferred embodiment recites rendering a first view in the user interface. Preferably, the first view is rendered in the user interface in response to the imaginary vector intersecting the surface at a first latitudinal position. Block S102 of the preferred embodiment functions to display one or more of a virtual/augmented-reality view and a control view on the user interface for viewing and/or use by the user. As shown in FIG. 4, the imaginary vector can be any number of an infinite number of imaginary vectors V1, V2, VN that can interest the surface of the sphere 100 in one of at least two different latitudinal regions 102, 104.

Block S104 of the method of the preferred embodiment recites rendering a second view in the user interface. Preferably, the second view is rendered in response to the imaginary vector intersecting the surface at a second latitudinal position. Block S104 of the method of the preferred embodiment functions to display one or more of a virtual/augmented-reality view and a control view on the user interface for viewing and/or use by the user. More preferably, the second view is preferably one of the virtual/augmented-reality view or the control view and the first view is preferably its opposite. Alternatively, either one of the first or second view can be a hybrid view including a blend or partial display of both of the virtual/augmented-reality view or the control view. As shown in FIG. 4, the imaginary vector of block S104 can be any number of an infinite number of imaginary vectors V1, V2, VN that can interest the surface of the sphere 100 in one of at least two different latitudinal regions 102, 104. Preferably, in blocks S102 and S104, the different latitudinal regions 102, 104 correspond to different views as between the virtual/augmented-reality view and the control view.

As shown in FIG. 6, one variation of the method of the preferred embodiment includes block S112, which recites detecting a location of the user interface. Block S112 functions to receive, calculate, determine, and/or detect a geographical location of the user interface in real space. Preferably, the geographical location can be indoors, outdoors, above ground, below ground, in the air or on board an aircraft or other vehicle. Preferably, block S112 can be performed through wired or wireless means via one or more of a satellite positioning system, a local area network or wide area network such as a WiFi network, and/or a cellular communication network. A suitable satellite position system can include for example the GPS constellation of satellites, Galileo, GLONASS, or any other suitable territorial or national satellite positioning system. In one alternative embodiment, block S112 can be performed at least in part by a GPS transceiver, although any other type of transceiver for satellite-based location services can be employed in lieu of or in addition to a GPS transceiver.

As shown in FIG. 6, another variation of the method of the preferred embodiment can include blocks S106, S108, and S110, which recite detecting a pitch value, detecting a roll value, and detecting a yaw value, respectively. Blocks 106, S108, and S110 can function, alone or in combination, in determining, measuring, calculating, and/or detecting the orientation of the user interface. The quantities pitch value, roll value, and yaw value preferably correspond to various angular degrees shown in FIG. 1, which illustrates an possible orientation for a substantially rectangular apparatus having a preferred directionality conveyed by arrow A. The user interface of the method of the preferred embodiment can operate in a three-dimensional environment within which the user interface can be rotated through three-degrees of freedom. Preferably, the pitch value, roll value, and yaw value are mutually orthogonal angular values, the combination or sub-combination of which at least partially determine the orientation of the user interface in three dimensions.

Preferably, one or more of blocks S106, S108, and S110 can be performed by an IMU, which can include one or more of a MEMS gyroscope, a three-axis magnetometer, a three-axis accelerometer, or a three-axis gyroscope in any suitable configuration or combination. Alternatively, the IMU can include one or more of one or more single-axis and/or double-axis sensors of the type noted above in a suitable combination for rendering three-dimensional positional information. Preferably, the IMU can include a suitable combination of sensors to determine a roll value, a pitch value, and a yaw value as shown in FIG. 1. Alternatively, the IMU can preferably include a suitable combination of sensors to generate a non-transitory signal indicative of a rotation matrix descriptive of the three-dimensional orientation of the apparatus.

In another variation of the method of the preferred embodiment, the first view includes one of a virtual reality view or an augmented reality view. A virtual reality view of the method of the preferred embodiment can include one or more models or simulations of real space that are based on—but not photographic replicas of—the real space that the user is wishing to view. The augmented reality view of the method of the preferred embodiment can include either a virtual image or a real image of the real space augmented by additional superimposed and computer-generated interactive media including, such as additional images of a particular aspect of the image, hyperlinks, coupons, narratives, reviews, additional images and/or views of an aspect of the image, or any suitable combination thereof.

The augmented and/or virtual reality views can include or incorporate one or more of: photographic images of real space corresponding to an imaginary vector and/or frustum as shown in FIG. 4; modeled images of real space corresponding to the imaginary vector and/or frustum shown in FIG. 4; simulated images of real space corresponding to the imaginary vector and/or frustum as shown in FIG. 4, or any suitable combination thereof. Real space images can be preferably be received and/or processed by a camera connected to or integral with the user interface and oriented in the direction of the imaginary vector and/or frustum shown in FIG. 2. Preferably, the virtual and augmented reality view can be rendered through any suitable platform such as OpenGL, WebGL, or Direct3D. In one variation, HTML5 and CSS3 transforms are used to render the virtual and augmented reality view where the device orientation is fetched (e.g., through HTML5 or a device API) and used to periodically update (e.g., 60 frames per second) the CSS transform properties of media of the virtual and augmented reality view.

In another variation of the method of the preferred embodiment, the second view can include a user control view. The user control view of the method of the preferred embodiment functions to permit a user to control one or more functions of an apparatus through or with the assistance of the user interface. As an example, if the apparatus is a tablet computer or other mobile handheld device of the type described above, the user control view can include one or more switches, controls, keyboards and the like for controlling one or more aspects or functions of the apparatus. Alternatively, the user control view of the method of the preferred embodiment can include a standard interface, such as a browser, for presenting information to a user. In one example embodiment, a user can “select” a real object in a augmented-reality or virtual-reality mode (for example a hotel) and then transition to the control mode in which the user might be directed to the hotel's webpage or other webpages relating to the hotel.

In another variation of the method of the preferred embodiment, the first latitudinal position can be relatively higher than the second latitudinal position. As shown in FIG. 4, a latitudinal position of an imaginary vector V1 is higher than that of an imaginary vector V2, and the latter is beneath a critical latitude indicating that the displayable view is distinct from that shown when the user interface is oriented to the first latitudinal position. In another variation of the method of the preferred embodiment, the critical latitude corresponds to a predetermined pitch range, a predetermined yaw range, and a predetermined roll range. As noted above, the pitch value, yaw value, and roll value are all preferably measurable according to the method of the preferred embodiment. As noted above, FIG. 4 illustrates the critical latitude as substantially planar in form and substantially parallel to the azimuth. In other alternative embodiments, the critical latitude can be non-planar in shape (i.e., convex or concave) and oriented at acute or obtuse angle relative to the azimuth.

Preferably, upon a determination that a predetermined pitch range, predetermined yaw range, and/or a predetermined roll range is satisfied, the method of the preferred embodiment causes the transition between the first view and the second view on the user interface. As an example, the method of the preferred embodiment can transition between the first and second views in response to a pitch value of less/greater than forty-five degrees below the azimuth. Alternatively, the method of the preferred embodiment can transition between the first and second views in response to a roll value of less/greater than forty-five degrees below the azimuth.

In another variation of the method of the preferred embodiment, the predetermined yaw range is between zero and one hundred eighty degrees about an imaginary line substantially perpendicular to the imaginary vector V. As shown described above with reference FIG. 1, an user interface of the preferred embodiment can have a desirable orientation along arrow A, which comports with the user interface having a “top” and “bottom” a user just as a photograph or document would have a “top” and “bottom.” The direction of the arrow A shown in FIG. 1 can be measured as a yaw angle as shown in FIG. 1. Accordingly, in this variation of the method of the preferred embodiment, the “top” and “bottom” of the user interface can be rotatable and/or interchangeable such that in response to a rotation of approximately one hundred eighty degrees of yaw, the “top” and “bottom” can rotate to maintain an appropriate viewing angle for the user. In another alternative, the predetermined yaw value range can be between zero and approximately M degrees, wherein M degrees is approximately equal to three hundred sixty degrees divided by the number of sides S of the user interface. Thus, for S equals four sides, the predetermined yaw value range can be between zero and ninety degrees. Similarly, for S equals six sides, the predetermined yaw value range can be between zero and sixty degrees. Finally, for a substantially circular user interface, the view of the user interface can rotate with the increase/decrease in yaw value in real time or near real time to maintain the desired viewing orientation for the user.

In additional variations of the method of the preferred embodiment, the apparatus can employ any suitable measuring system and coordinate system for determining a relative orientation of the apparatus 10 in three dimensions. As noted above, the IMU of the method of the preferred embodiment can include any suitable sensor configured to produce a rotation matrix descriptive of the orientation of the apparatus. Preferably, the orientation of the apparatus can be calculated as a point on an imaginary unit sphere (co-spherical with the imaginary sphere shown in FIG. 4) in Cartesian or any other suitable coordinates. Alternatively, the orientation of the apparatus can be calculated as an angular rotation about the imaginary vector to the point on the imaginary unit sphere. As noted above, a pitch angle of negative forty-five degrees corresponds to a declination along the z-axis in a Cartesian system. In particular, a negative forty-five degree pitch angle corresponds to a z value of approximately 0.707, which is approximately the sine of forty-five degrees or one half the square root of two. Accordingly, calculation of the orientation in the method of the preferred embodiment can also be calculated, computed, determined, and/or presented more than one type of coordinates and in more than one type of coordinate system. Those of skill in the art will readily appreciate that performance of the method of the preferred embodiment is not limited to either Euler coordinates or Cartesian coordinates, nor to any particular combination or sub-combination of orientation sensors. Those of skill in the art will additionally recognize that one or more frames of reference for each of the suitable coordinate systems are readily usable, including for example at least an apparatus frame of reference and an external (real world) frame of reference).

### 2B. Method for Transitioning a User Interface Between Two Viewing Modes.

As shown in FIG. 7, a method of the preferred embodiment can include detecting an orientation of a mobile terminal in block S200 and transitioning between at least two viewing modes in block S202. The method of the preferred embodiment function to cause a mobile, preferably including a display and/or a user interface, to transition between at least two viewing modes. Preferably, as described below, the at least two viewing modes can include a reality mode (including for example a virtual and/or augmented reality view) and a control mode.

Block S200 of the method of the preferred embodiment recites detecting an orientation of a mobile terminal. A mobile terminal can include any type of apparatus described above, as well as a head-mounted display of the type described below. Preferably, the mobile terminal includes a user interface disposed on a first side of the mobile terminal, and the user interface preferably includes a display of the type described above. In one variation of the method of the preferred embodiment, the orientation of the mobile terminal can include an imaginary vector originating at a second side of the mobile terminal and projecting in a direction substantially opposite the first side of the mobile terminal. For example, the imaginary vector relating to the orientation can be substantially collinear and/or parallel with a line-of-sight of a user such that a display disposed on the first side of the mobile terminal functions substantially as a window through which the user views for example an augmented or virtual reality.

Block S202 recites transitioning between at least two viewing modes. Block S202 functions to change, alter, substitute, and/or edit viewable content, either continuously or discretely, such that the view of a user is in accordance with an augmented/virtual reality or a control interface for the mobile terminal. Preferably, the transition of block S202 occurs in response to the imaginary vector intersecting an imaginary sphere disposed about the mobile terminal first latitudinal point having a predetermined relationship to a critical latitude of the sphere, as shown in FIG. 4. As previously described, FIG. 4 illustrates imaginary vector V1 intersecting the sphere 100 at a point above the critical latitude and imaginary vector V2 intersecting the sphere 100 at a point below the critical latitude. In the preferred embodiments described above, the top portion of the sphere 100 corresponds with the augmented-reality or virtual-reality viewing mode and the bottom portion corresponds with the control-interface viewing mode.

As shown in FIG. 7, one variation of the method of the preferred embodiment includes block S204, which recites determining a location of the mobile terminal. Block S204 functions to receive, calculate, determine, and/or detect a geographical location of the user interface in real space. Preferably, the geographical location can be indoors, outdoors, above ground, below ground, in the air or on board an aircraft or other vehicle. Preferably, block S204 can be performed through wired or wireless means via one or more of a satellite positioning system, a local area network or wide area network such as a WiFi network, and/or a cellular communication network. A suitable satellite position system can include for example the GPS constellation of satellites, Galileo, GLONASS, or any other suitable territorial or national satellite positioning system. In one alternative embodiment, block S204 can be performed at least in part by a GPS transceiver, although any other type of transceiver for satellite-based location services can be employed in lieu of or in addition to a GPS transceiver.

As shown in FIG. 7, another variation of the method of the preferred embodiment can include blocks S206, S208, and S210, which recite detecting a pitch value, detecting a roll value, and detecting a yaw value, respectively. Blocks S206, S208, and S210 can function, alone or in combination, in determining, measuring, calculating, and/or detecting the orientation of the user interface. The quantities pitch value, roll value, and yaw value preferably correspond to various angular degrees shown in FIG. 1, which illustrates an possible orientation for a substantially rectangular apparatus having a preferred directionality conveyed by arrow A. The user interface of the method of the preferred embodiment can operate in a three-dimensional environment within which the user interface can be rotated through three-degrees of freedom. Preferably, the pitch value, roll value, and yaw value are mutually orthogonal angular values, the combination or sub-combination of which at least partially determine the orientation of the user interface in three dimensions.

Preferably, one or more of blocks S206, S208, and S210 can be performed by an IMU, which can include one or more of a MEMS gyroscope, a three-axis magnetometer, a three-axis accelerometer, or a three-axis gyroscope in any suitable configuration or combination. Alternatively, the IMU can include one or more of one or more single-axis and/or double-axis sensors of the type noted above in a suitable combination for rendering three-dimensional positional information. Preferably, the IMU can include a suitable combination of sensors to determine a roll value, a pitch value, and a yaw value as shown in FIG. 1. Alternatively, the IMU can preferably include a suitable combination of sensors to generate a non-transitory signal indicative of a rotation matrix descriptive of the three-dimensional orientation of the apparatus.

As shown in FIG. 7, another variation of the method of the preferred embodiment can include blocks S212 and S214, which recite rendering a first viewing mode and rendering a second viewing mode, respectively. The first and second viewing modes of the method of the preferred embodiment function to display one or more of a virtual/augmented-reality view and a control view on the user interface for viewing and/or use by the user. More preferably, the first viewing mode is preferably one of the virtual/augmented-reality view or the control view and the second viewing mode is preferably its opposite. Alternatively, either one of the first or second viewing modes can be a hybrid view including a blend or partial display of both of the virtual/augmented-reality view or the control view.

In another variation of the method of the preferred embodiment, the first viewing mode includes one of a virtual reality mode or an augmented reality mode. A virtual reality mode of the method of the preferred embodiment can include one or more models or simulations of real space that are based on—but not photographic replicas of—the real space that the user is wishing to view. The augmented reality mode of the method of the preferred embodiment can include either a virtual image or a real image of the real space augmented by additional superimposed and computer-generated interactive media including, such as additional images of a particular aspect of the image, hyperlinks, coupons, narratives, reviews, additional images and/or views of an aspect of the image, or any suitable combination thereof.

The augmented and/or virtual reality modes can include or incorporate one or more of: photographic images of real space corresponding to an imaginary vector and/or frustum as shown in FIG. 4; modeled images of real space corresponding to the imaginary vector and/or frustum shown in FIG. 4; simulated images of real space corresponding to the imaginary vector and/or frustum as shown in FIG. 4, or any suitable combination thereof. Real space images can be preferably be received and/or processed by a camera connected to or integral with the user interface and oriented in the direction of the imaginary vector and/or frustum shown in FIG. 2. Preferably, the virtual and augmented reality modes can be rendered through any suitable platform such as OpenGL, WebGL, or Direct3D. In one variation, HTML5 and CSS3 transforms are used to render the virtual and augmented reality view where the device orientation is fetched (e.g., through HTML5 or a device API) and used to periodically update (e.g., 60 frames per second) the CSS transform properties of media of the virtual and augmented reality view.

In another variation of the method of the preferred embodiment, the second viewing mode can include a control mode. The control mode of the method of the preferred embodiment functions to permit a user to control one or more functions of an apparatus through or with the assistance of the user interface. As an example, if the apparatus is a tablet computer or other mobile handheld device of the type described above, the user control view can include one or more switches, controls, keyboards and the like for controlling one or more aspects or functions of the apparatus. Alternatively, the control mode of the method of the preferred embodiment can include a standard user interface, such as a browser, for presenting information to a user. In one example embodiment, a user can “select” a real object in a augmented-reality or virtual-reality mode (for example a hotel) and then transition to the control mode in which the user might be directed to the hotel's webpage or other webpages relating to the hotel.

In another variation of the method of the preferred embodiment, the predetermined pitch range is more than approximately forty-five degrees below the azimuth. As shown in FIG. 4, imaginary vector V1 has a pitch angle of less than forty-five degrees below the azimuth, while imaginary vector V2 has a pitch angle of more than forty-five degrees below the azimuth. As shown, imaginary vector V1 intersects the surface of the sphere 100 in a first portion 102, which is above the critical latitude, and imaginary vector V2 intersects the sphere 100 in a second portion 104 below the critical latitude. Preferably, the different portions 102, 104 of the sphere 100 correspond to the one or more viewing modes of the apparatus 10. Preferably, the predetermined pitch range is such that the orientation of the user interface will be more horizontally disposed than vertically disposed (relative to the azimuth) as noted above.

In another variation of the method of the preferred embodiment, the predetermined yaw range is between zero and one hundred eighty degrees about an imaginary line substantially perpendicular to the imaginary vector V. As shown in FIG. 1, the apparatus 10 of the preferred embodiment can have a desirable orientation along arrow A, which comports with the apparatus 10 having a “top” and “bottom” a user just as a photograph or document would have a “top” and “bottom.” The direction of the arrow A shown in FIG. 1 can be measured as a yaw angle as shown in FIG. 1. Accordingly, in this variation of the method of the preferred embodiment, the “top” and “bottom” of the apparatus 10 can be rotatable and/or interchangeable such that in response to a rotation of approximately one hundred eighty degrees of yaw, the “top” and “bottom” can rotate to maintain an appropriate viewing angle for the user. In another alternative, the predetermined yaw value range can be between zero and approximately M degrees, wherein M degrees is approximately equal to three hundred sixty degrees divided by the number of sides S of the user interface. Thus, for S equals four sides, the predetermined yaw value range can be between zero and ninety degrees. Similarly, for S equals six sides, the predetermined yaw value range can be between zero and sixty degrees. Finally, for a substantially circular user interface, the view of the user interface can rotate with the increase/decrease in yaw value in real time or near real time to maintain the desired viewing orientation for the user.

In another variation of the method of the preferred embodiment, the predetermined roll range is more than approximately forty-five degrees below the azimuth. As shown in FIG. 4, imaginary vector V1 has a roll angle of less than forty-five degrees below the azimuth, while imaginary vector V2 has a roll angle of more than forty-five degrees below the azimuth. As previously noted, imaginary vector V1 intersects the surface of the sphere 100 in the first portion 102 and imaginary vector V2 intersects the sphere 100 in a second portion 104. Preferably, the different portions 102, 104 of the sphere 100 correspond to the one or more viewing modes of the apparatus 10. Preferably, the predetermined roll range is such that the orientation of the user interface will be more horizontally disposed than vertically disposed (relative to the azimuth) as noted above.

In additional variations of the method of the preferred embodiment, the apparatus can employ any suitable measuring system and coordinate system for determining a relative orientation of the apparatus 10 in three dimensions. As noted above, the IMU of the method of the preferred embodiment can include any suitable sensor configured to produce a rotation matrix descriptive of the orientation of the apparatus. Preferably, the orientation of the apparatus can be calculated as a point on an imaginary unit sphere (co-spherical with the imaginary sphere shown in FIG. 4) in Cartesian or any other suitable coordinates. Alternatively, the orientation of the apparatus can be calculated as an angular rotation about the imaginary vector to the point on the imaginary unit sphere. As noted above, a pitch angle of negative forty-five degrees corresponds to a declination along the z-axis in a Cartesian system. In particular, a negative forty-five degree pitch angle corresponds to a z value of approximately 0.707, which is approximately the sine of forty-five degrees or one half the square root of two. Accordingly, calculation of the orientation in the method of the preferred embodiment can also be calculated, computed, determined, and/or presented more than one type of coordinates and in more than one type of coordinate system. Those of skill in the art will readily appreciate that performance of the method of the preferred embodiment is not limited to either Euler coordinates or Cartesian coordinates, nor to any particular combination or sub-combination of orientation sensors. Those of skill in the art will additionally recognize that one or more frames of reference for each of the suitable coordinate systems are readily usable, including for example at least an apparatus frame of reference and an external (real world) frame of reference).

### 3. Example Operation of the Preferred Apparatus and Methods

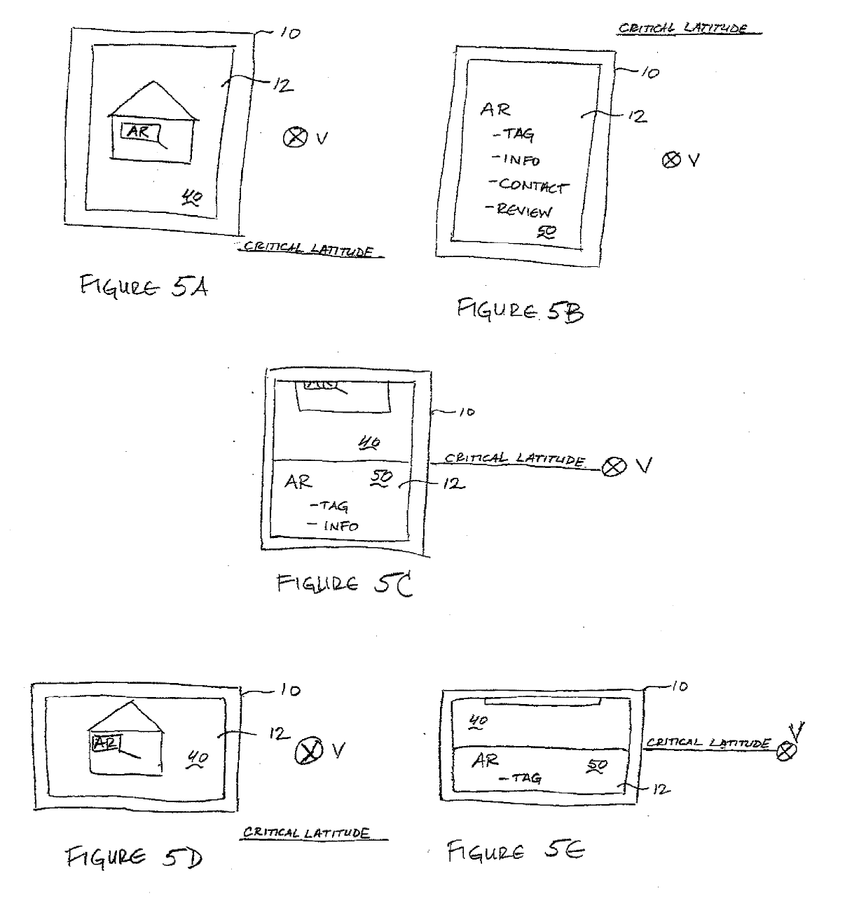

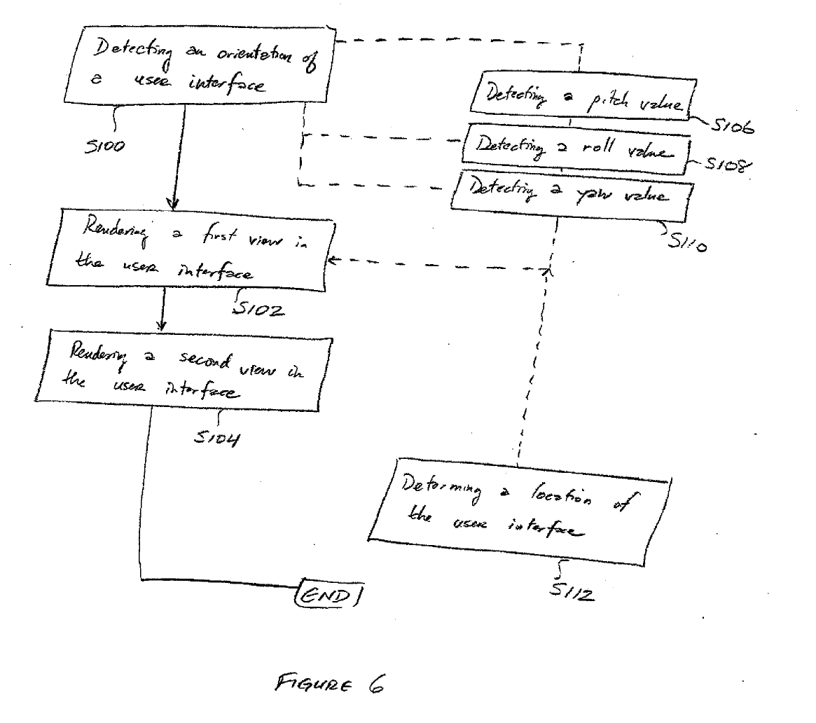

FIG. 5A schematically illustrates the apparatus 10 and methods of the preferred embodiment in an augmented-reality viewing mode 40 displayed on the user interface 12. As shown, the imaginary vector V is entering the page above the critical latitude, i.e., such that that pitch value is substantially less than the critical latitude. The augmented-reality viewing mode 40 of the preferred embodiment can include one or more tags (denoted AR) permitting a user to access additional features about the object displayed.

FIG. 5B schematically illustrates the apparatus 10 and methods of the preferred embodiment in a control-viewing mode 50 displayed on the user interface 12. As shown, the imaginary vector V is entering the page below the critical latitude, i.e., such that the pitch value is substantially greater than the critical latitude. The control-viewing mode 50 of the preferred embodiment can include one or more options, controls, interfaces, and/or interactions with the AR tag selectable in the augmented-reality viewing mode 40. Example control features shown in FIG. 5B include tagging an object or feature for later reference, retrieving information about the object or feature, contacting the object or feature, reviewing and/or accessing prior reviews about the object or feature and the like.

As shown in FIG. 5C, a third viewing mode according to the apparatus 10 and methods of the preferred embodiment can include a hybrid-viewing mode between the augmented/virtual-reality viewing mode 40 and the control-viewing mode 50. As shown, the imaginary vector V is entering the page at or near the transition line that divides the augmented/virtual-reality viewing mode 40 and the control-viewing mode 50, which in turn corresponds to the pitch value being approximately at or on the critical latitude. The hybrid-viewing mode preferably functions to transition between the augmented/virtual-reality viewing mode 40 and the control-viewing mode 50 in both directions. That is, the hybrid-viewing mode preferably functions to gradually transition the displayed information as the pitch value increases and decreases. In one variation of the apparatus 10 and methods of the preferred embodiment, the hybrid-viewing mode can transition in direct proportion to a pitch value of the apparatus 10. Alternatively, the hybrid-viewing mode can transition in direct proportion to a rate of change in the pitch value of the apparatus 10. In yet another alternative, the hybrid-viewing mode can transition in direct proportion to a weighted or unweighted blend of the pitch value, rate of change in the pitch value (angular velocity), and/or rate of change in the angular velocity (angular acceleration.) Alternatively, the hybrid-viewing mode can transition in a discrete or stepwise fashion in response to a predetermined pitch value, angular velocity value, and/or angular acceleration value. Alternatively, the apparatus 10 and methods of the preferred embodiment can utilize a hysteresis function to prevent unintended transitions between the at least two viewing modes.

As shown in FIG. 5D, the apparatus 10 and methods of the preferred embodiment can function substantially identically independent of the particular orientation of its own sides. In the example rectangular configuration shown, FIG. 5D is substantially identical to FIG. 5A with the exception of the relative position of the longer and shorter sides of the apparatus 10 (also known as “portrait” and “landscape” views). As shown, the imaginary vector V is entering the page substantially above the critical latitude, such that the roll value is substantially less than the critical latitude. The augmented-reality viewing mode 40 of the preferred embodiment can include one or more tags (denoted AR) permitting a user to access additional features about the object displayed.

Similarly, as shown in FIG. 5E, the hybrid-viewing mode is operable in an askew orientation of the apparatus 10 of the preferred embodiment. As shown, the imaginary vector V is entering the page at or near the transition line that divides the augmented/virtual-reality viewing mode 40 and the control-viewing mode 50, which in turn corresponds to the roll value being approximately at or one the critical latitude. As noted above, the hybrid-viewing mode preferably functions to transition between the augmented/virtual-reality viewing mode 40 and the control-viewing mode 50 in both directions. In one variation of the apparatus 10 and methods of the preferred embodiment, the hybrid-viewing mode can transition in direct proportion to a roll value of the apparatus 10. Alternatively, the hybrid-viewing mode can transition in direct proportion to a rate of change in the roll value of the apparatus 10. In yet another alternative, the hybrid-viewing mode can transition in direct proportion to a weighted or unweighted blend of the roll value, rate of change in the roll value (angular velocity), and/or rate of change in the angular velocity (angular acceleration.) Alternatively, the hybrid-viewing mode can transition in a discrete or stepwise fashion in response to a predetermined roll value, angular velocity value, and/or angular acceleration value. Alternatively, the apparatus 10 and methods of the preferred embodiment can utilize a hysteresis function to prevent unintended transitions between the at least two viewing modes.

As an exemplary application of the preferred apparatus and methods, a program on an apparatus such as a smartphone or tablet computer can be used to navigate to different simulated real-world locations. The real-world locations are preferably spherical images from different geographical locations. When holding the apparatus predominately upward, the user can turn around, tilt and rotate the phone to explore the simulated real-world location as if he was looking through a small window into the world. By moving the phone flat, and looking down on it, the phone enters a navigation user interface that displays a graphic of a map with different interest points. Selecting one of the interest points preferably changes the simulated real-world location to that interest point. Returning to an upward position, the phone transitions out of the navigation user interface to reveal the virtual and augmented reality interface with the newly selected location. As an example, the user can perform large scale navigation in the control mode, i.e., moving a pin or avatar between streets in a city, then enter the augmented-reality or virtual-reality mode at a point in the city to experience an immersive view of the location in all directions through the display of the apparatus 10.

As another exemplary application of a preferred apparatus and methods, the apparatus can be used to annotate, alter, affect, and/or interact with elements of a virtual and augmented reality view. While in a virtual and augmented reality view, an object or point can be selected (e.g., either through taping a touch screen, using the transition selection step described above, or using any suitable technique). Then, when in the interactive control mode, an annotation tool can be used to add content or interact with that selected element of the virtual and augmented reality view. The annotation can be text, media, or any suitable parameter including for example photographs, hyperlinks, and the like. After adding an annotation, when in the virtual and augmented reality mode, the annotation is preferably visible at least to the user. As an example, a user can tap on a location in the augmented reality or virtual reality mode and annotate, alter, affect, and/or interact with it in the control interface mode as a location that he or she has recently visited, a restaurant at which he or she has dined, which annotation/s, alteration/s, affect/s, and/or interaction/s will be visible to the user when entering the augmented reality or virtual reality mode once again. Conversely, a user's actions (e.g., annotation, alteration, affectation, interaction) in the augmented reality or virtual reality mode can be made visible to the user when in the control interface mode. As an example, if a user tags a pins a location in the augmented reality mode, such a tag or pin can be visible to the user in the control interface mode, for example as a pin dropped on a two-dimensional map displayable to the user.

### 4. Method of Presenting a VAR Scene to a User

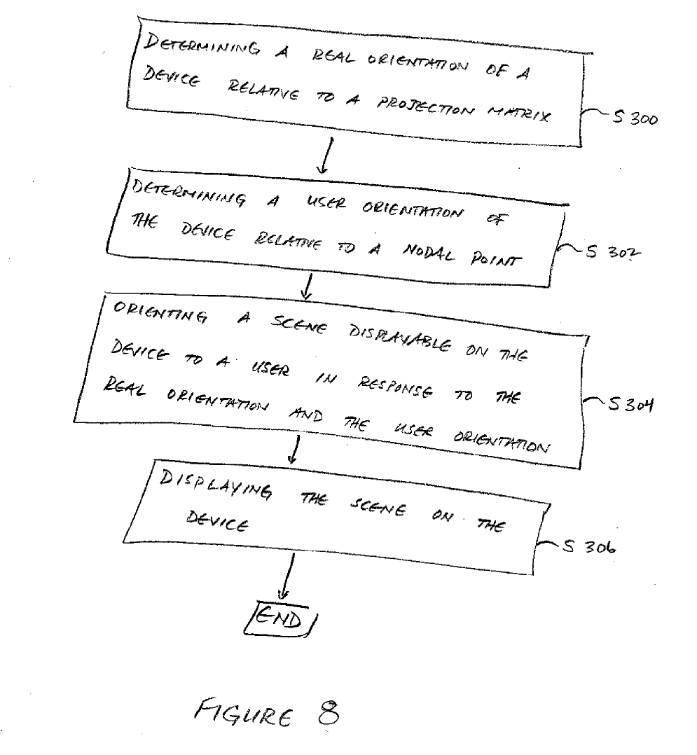

As shown in FIG. 8, a method of a preferred embodiment can include determining a real orientation of a device relative to a projection matrix in block S300 and determining a user orientation of the device relative to a nodal point in block S302. The method of the preferred embodiment can further include orienting a scene displayable on the device to the user in response to the real orientation and the user orientation in block S304 and displaying the scene on the device in block S306. The method of the preferred embodiment functions to present a virtual and/or augmented reality (VAR) scene to a user from the point of view of a nodal point or center thereof, such that it appears to the user that he or she is viewing the world (represented by the VAR scene) through a frame of a window. The method of the preferred embodiment can be performed at least in part by any number of selected devices, including any mobile computing devices such as smart phones, personal computers, laptop computers, tablet computers, or any other device of the type described below.

As shown in FIG. 8, the method of the preferred embodiment can include block S300, which recites determining a real orientation of a device relative to a projection matrix. Block S300 functions to provide a frame of reference for the device as it relates to a world around it, wherein the world around can include real three dimensional space, a virtual reality space, an augmented reality space, or any suitable combination thereof. Preferably, the projection matrix can include a mathematical representation of an arbitrary orientation of a three-dimensional object having three degrees of freedom relative to a second frame of reference. As an example, the projection matrix can include a mathematical representation of a device's orientation in terms of its Euler angles (pitch, roll, yaw) in any suitable coordinate system. In one variation of the method of the preferred embodiment, the second frame of reference can include a three-dimensional external frame of reference (i.e., real space) in which the gravitational force defines baseline directionality for the relevant coordinate system against which the absolute orientation of the device can be measured. Preferably, the real orientation of the device can include an orientation of the device relative to the second frame of reference, which as noted above can include a real three-dimensional frame of reference. In such an example implementation, the device will have certain orientations corresponding to real world orientations, such as up and down, and further such that the device can be rolled, pitched, and/or yawed within the external frame of reference.

As shown in FIG. 8, the method of the preferred embodiment can also include block S302, which recites determining a user orientation of the device relative to a nodal point. Block S302 preferably functions to provide a frame of reference for the device relative to a point or object in space, including a point or object in real space. Preferably, the user orientation can include a measurement of a distance and/or rotational value/s of the device relative to the nodal point. In another variation of the method of the preferred embodiment, the nodal point can include a user's head such that the user orientation includes a measurement of the relative distance and/or rotational value/s of the device relative to a user's field of view. Alternatively, the nodal point can include a portion of the user's head, such as for example a point between the user's eyes. In another alternative, the nodal point can include any other suitable point in space, including for example any arbitrary point such as an inanimate object, a group of users, a landmark, a location, a waypoint, a predetermined coordinate, and the like. Preferably, the user orientation functions to create a viewing relationship between a user (optionally located at the nodal point) and the device, such that a change in user orientation can cause a consummate change in viewable content consistent with the user's VAR interaction, i.e., such that the user's view through the frame will be adjusted consistent with the user's orientation relative to the frame.

As shown in FIG. 18, the method of the preferred embodiment can also include block S304, which recites orienting a scene displayable on the device to a user in response to the real orientation and the user orientation. Block S304 preferably functions to process, compute, calculate, determine, and/or create a VAR scene that can be displayed on the device to a user, wherein the VAR scene is oriented to mimic the effect of the user viewing the VAR scene as if through the frame of the device. Preferably, orienting the scene can include preparing a VAR scene for display such that the viewable scene matches what the user would view in a real three-dimensional view, that is, such that the displayable scene provides a simulation of real viewable space to the user as if the device were a transparent frame. As noted above, the scene is preferably a VAR scene, therefore it can include one or more virtual and/or augmented reality elements composing, in addition to, and/or in lieu of one or more real elements (buildings, roads, landmarks, and the like, either real or fictitious). Alternatively, the scene can include processed or unprocessed images/videos/multimedia files of a multitude of scene aspects, including both actual and fictitious elements as noted above.

As shown in FIG. 8, the method of the preferred embodiment can further include block S306, which recites displaying the scene on the device. Block S306 preferably functions to render, present, project, image, and/or display viewable content on, in, or by a device of the type described below. Preferably, the displayable scene can include a spherical image of a space having virtual and/or augmented reality components. In one variation of the method of the preferred embodiment, the spherical image displayable on the device can be substantially symmetrically disposed about the nodal point, i.e. the nodal point is substantially coincident with and/or functions as an origin of a spheroid upon which the image is rendered.

In another variation of the method of the preferred embodiment, the method can include displaying portion of the spherical image in response to the real orientation of the device. Preferably, the portion of the spherical image that is displayed corresponds to an overlap between a viewing frustum of the device (i.e., a viewing cone projected from the device) and the imaginary sphere that includes the spherical image. The resulting displayed portion of the spherical image is preferably a portion of the spherical image, which can include a substantially rectangular display of a concave, convex, or hyperbolic rectangular portion of the sphere of the spherical image. Preferably, the nodal point is disposed at approximately the origin of the spherical image, such that a user has the illusion of being located at the center of a larger sphere or bubble having the VAR scene displayed on its interior. Alternatively, the nodal point can be disposed at any other suitable vantage point within the spherical image displayable by the device. In another alternative, the displayable scene can include a substantially planar and/or ribbon-like geometry from which the nodal point is distanced in a constant or variable fashion. Preferably, the display of the scene can be performed within a 3D or 2D graphics platform such as OpenGL, WebGL, or Direct 3D. Alternatively, the display of the scene can be performed within a browser environment using one or more of HTML5, CSS3, or any other suitable markup language. In another variation of the method of the preferred embodiment, the geometry of the displayable scene can be altered and/or varied in response to an automated input and/or in response to a user input.

As shown in FIG. 9, another variation of the method of the preferred embodiment can include block S308, which recites creating a projection matrix representative of a device orientation in a three-dimensional external frame of reference. Block S308 preferably functions to coordinate the displayable scene with a physical orientation of the device as established by and/or relative to a user. As noted above, the projection matrix preferably includes a mathematical representation of an arbitrary orientation of a three-dimensional object having three degrees of freedom relative to the external frame of reference. In one variation of the method of the preferred embodiment, the external frame of reference can include a three-dimensional external frame of reference (i.e., real space) in which the gravitational force defines baseline directionality for the relevant coordinate system against which the absolute orientation of the device can be measured. Alternatively, the external frame of reference can include a fictitious external frame of reference, i.e., such as that encountered in a film or novel, whereby any suitable metrics and/or geometries can apply for navigating the device through the pertinent orientations. One example of a fictitious external frame of reference can include a fictitious space station frame of reference, wherein there is little to no gravitational force to provide the baseline directionality noted above. In such an example implementation, the external frame of reference can be fitted or configured consistently with the other features of the VAR scene.

As shown in FIG. 10, another variation of the method of the preferred embodiment can include block S310, which recites adapting the scene displayable on the device to the user in response to a change in one of the real orientation or the user orientation. Block S310 preferably functions to alter, change, reconfigure, recompute, regenerate, and/or adapt the displayable scene in response to a change in the real orientation or the user orientation. Additionally, block S310 preferably functions to create a uniform and immersive user experience by adapting the displayable scene consistent with movement of the device relative to the projection matrix and/or relative to the nodal point. Preferably, adapting the displayable scene can include at least one of adjusting a virtual zoom of the scene, adjusting a virtual parallax of the scene, adjusting a virtual perspective of the scene, and/or adjusting a virtual origin of the scene. Alternatively, adapting the displayable scene can include any suitable combination of the foregoing, performed substantially serially or substantially simultaneously, in response to a timing of any determined changes in one or both of the real orientation or the user orientation.

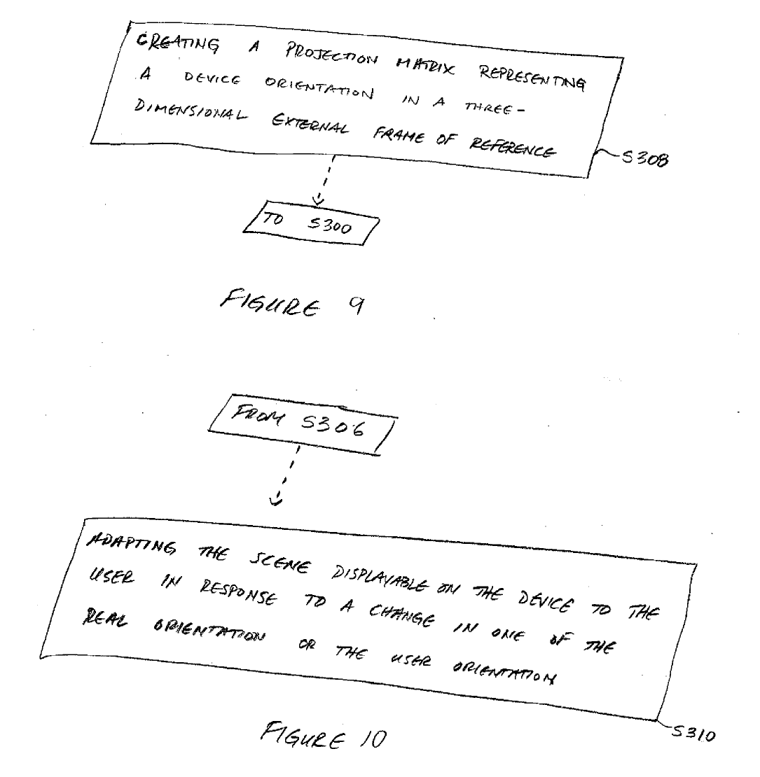

As shown in FIG. 11, another variation of the method of the preferred embodiment can include block S312, which recites adjusting a virtual zoom of the scene in response to a change in a linear distance between the device and the nodal point. Block S312 preferably functions to resize one or more displayable aspects of the scene in response to a distance between the device and the nodal point to mimic a change in the viewing distance of the one or more aspects of the scene. As noted above, the nodal point can preferably be coincident with a user's head, such that a distance between the device and the nodal point correlates substantially directly with a distance between a user's eyes and the device. Accordingly, adjusting a virtual zoom can function in part to make displayable aspects of the scene relatively larger in response to a decrease in distance between the device and the nodal point; and to make displayable aspects of the scene relatively smaller in response to an increase in distance between the device and the nodal point. Another variation of the method of the preferred embodiment can include measuring a distance between the device and the nodal point, which can include for example using a front facing camera to measure the relative size of the nodal point (i.e., the user's head) in order to calculate the distance. Alternatively, the adjustment of the virtual zoom can be proportional to a real zoom (i.e., a real relative sizing) of the nodal point (i.e., the user's head) as captured by the device camera. Accordingly, as the distance decreases/increases, the size of the user's head will appear to increase/decrease, and the adjustment in the zoom can be linearly and/or non-linearly proportional to the resultant increase/decrease imaged by the camera. Alternatively, the distance between the nodal point and the device can be measured and/or inferred from any other suitable sensor and/or metric, including at least those usable by the device in determining the projection matrix as described below, including for example one or more cameras (front/rear), an accelerometer, a gyroscope, a MEMS gyroscope, a magnetometer, a pedometer, a proximity sensor, an infrared sensor, an ultrasound sensor, and/or any suitable combination thereof.

As shown in FIG. 11, another variation of the method of the preferred embodiment can include block S314, which recites adjusting a virtual parallax of the scene in response to a change in a translational distance between the device and the nodal point. Block S314 preferably functions to reorient the relative size and/or placement of one or more aspects of the displayable scene in response to a translational movement between the device and the nodal point. A translational movement can include for example a relative movement between the nodal point and the device in or along a direction substantially perpendicular to a line of sight from the nodal point, i.e., substantially tangential to an imaginary circle having the nodal point as its origin. As noted above, the nodal point can preferably be coincident with a user's head, such that the translational distance between the device and the nodal point correlates substantially directly with a distance between a user's eyes and the device. Accordingly, adjusting a virtual parallax can function in part to adjust a positioning of certain displayable aspects of the scene relative to other displayable aspects of the scene. In particular, adjusting a virtual parallax preferably causes one or more foreground aspects of the displayable scene to move relative to one or more background aspects of the displayable scene. Another variation of the method of the preferred embodiment can include identifying one or more foreground aspects of the displayable scene and/or identifying one or more background aspects of the displayable scene. Preferably, the one or more foreground aspects of the displayable scene are movable with respect to the one ore more background aspects of the displayable scene such that, in block S314, the method of the preferred embodiment can create and/or adjust a virtual parallax viewing experience for a user in response to a change in the translational distance between the device and the nodal point.

Another variation of the method of the preferred embodiment can include measuring a translational distance between the device and the nodal point, which can include for example using a front facing camera to measure the relative size and/or location of the nodal point (i.e., the user's head) in order to calculate the translational distance. Alternatively, the translational distance between the nodal point and the device can be measured and/or inferred from any other suitable sensor and/or metric, including at least those usable by the device in determining the projection matrix as described below, including for example one or more cameras (front/rear), an accelerometer, a gyroscope, a MEMS gyroscope, a magnetometer, a pedometer, a proximity sensor, an infrared sensor, an ultrasound sensor, and/or any suitable combination thereof. Preferably, the translational distance can be measured by a combination of the size of the nodal point (from the front facing camera) and a detection of a planar translation of the device in a direction substantially orthogonal to the direction of the camera, thus indicating a translational movement without any corrective rotation. For example, one or more of the foregoing sensors can determine that the device is moved in a direction substantially orthogonal to the camera direction (tangential to the imaginary sphere surrounding the nodal point), while also determining that there is no rotation of the device (such that the camera is directed radially inwards towards the nodal point). Preferably, the method of the preferred embodiment can treat such a movement as translational in nature and adapt a virtual parallax of the viewable scene accordingly.

As shown in FIG. 11, another variation of the method of the preferred embodiment can include block S316, which recites adjusting a virtual perspective of the scene in response to a change in a rotational orientation of the device and the nodal point. Block S316 preferably functions to reorient, reshape, resize, and/or skew one or more aspects of the displayable scene to convey a sense of perspective and/or a non-plan viewing angle of the scene in response to a rotational movement of the device relative to the nodal point. Preferably, adjustment of the virtual perspective of the scene is related in part to a distance between one end of the device and the nodal point and a distance between the other end of the device and the nodal point. As an example, if a left/top side of the device is closer to the nodal point then the right/bottom side of the device, then aspects of the left/top portion of the scene should be adapted to appear relatively closer (i.e., displayable larger) than aspects of the right/bottom portion of the scene. Preferably, adjustment of the aspects of the scene to create the virtual perspective will apply both to foreground aspects and background aspects, such that the method of the preferred embodiment adjusts the virtual perspective of each aspect of the scene in response to at least its position in the scene, the degree of rotation of the device relative to the nodal point, the relative depth (foreground/background) of the aspect, and/or any other suitable metric or visual cue. As an example, lines that are parallel in the scene when the device is directed at the nodal point (all edges equidistant from the nodal point) will converge in some other direction in the display (i.e., to the left, right, top, bottom, diagonal, etc.) as the device is rotated. Preferably, if the device is rotated such that the left edge is closer to the nodal point than the right edge, then formerly parallel lines can be adjusted to converge towards infinity past the right edge of the device, thus conveying a sense of perspective to the user.

Another variation of the method of the preferred embodiment can include measuring a rotational orientation between the device and the nodal point, which can include for example using a front facing camera to measure the relative position of the nodal point (i.e., the user's head) in order to calculate the rotational orientation. Alternatively, the rotational orientation of the nodal point and the device can be measured and/or inferred from any other suitable sensor and/or metric, including at least those usable by the device in determining the projection matrix as described below, including for example one or more cameras (front/rear), an accelerometer, a gyroscope, a MEMS gyroscope, a magnetometer, a pedometer, a proximity sensor, an infrared sensor, an ultrasound sensor, and/or any suitable combination thereof. Preferably, the rotational orientation can be measured by a combination of the position of the nodal point (as detected by the front facing camera) and a detection of a rotation of the device that shifts the direction of the camera relative to the nodal point. As an example, a front facing camera can be used to determine a rotation of the device by detecting a movement of the nodal point within the field of view of the camera (indicating that the device/camera is being rotated in an opposite direction). Accordingly, if the nodal point moves to the bottom/right of the camera field of view, then the method of the preferred embodiment can determine that the device is being rotated in a direction towards the top/left of the camera field of view. In response to such a rotational orientation, the method of the preferred embodiment preferably mirrors, adjusts, rotates, and/or skews the viewable scene to match the displaced perspective that the device itself views through the front facing camera.

As shown in FIG. 11, another variation of the method of the preferred embodiment can include block S320, which recites adjusting a virtual origin of the scene in response to a change in a real position of the nodal point. Block S120 preferably functions to reorient, reshape, resize, and/or translate one or more aspects of the displayable scene in response to the detection of actual movement of the nodal point. In one variation of the method of the preferred embodiment, the nodal point can include an arbitrary point in real or fictitious space relative to which the scenes described herein are displayable. Accordingly, any movement of the real or fictitious nodal point preferably results in a corresponding adjustment of the displayable scene. In another variation of the method of the preferred embodiment, the nodal point can include a user's head or any suitable portion thereof. In such an implementation, movement of the user in real space can preferably be detected and used for creating the corresponding adjustments in the displayable scene. The real position of the nodal point can preferably be determined using any suitable combination of devices, including for example one or more cameras (front/rear), an accelerometer, a gyroscope, a MEMS gyroscope, a magnetometer, a pedometer, a proximity sensor, an infrared sensor, and/or an ultrasound sensor. As an example, a user can wear a pedometer in communication with the device such that when the user walks through real space, such movement of the user/nodal point is translated into movement in the VAR space, resulting in a corresponding adjustment to the displayable scene. Another variation of the method of the preferred embodiment can include determining a position and/or motion of the device in response to location service signal associated with the device. Example location service signals can include global positioning signals and/or transmission or pilot signals transmittable by the device in attempting to connect to an external network, such as a mobile phone or Wi-Fi type wireless network. Preferably, the real movement of the user/nodal point in space can result in the adjustment of the location of the origin/center/viewing point of the displayable scene.

In another variation of the method of the preferred embodiment, displaying the scene on the device can include displaying a floating-point exposure of the displayable scene in order to minimize lighting irregularities. As noted above, the displayable scene can be any suitable geometry, including for example a spherical image disposed substantially symmetrically about a nodal point. Displaying a floating-point exposure preferably functions to allow the user to view/experience the full dynamic range of the image without having to artificially adjust the dynamic range of the image. Preferably, the method of the preferred embodiment globally adjusts the dynamic range of the image such that a portion of the image in the center of the display is within the dynamic range of the device. By way of comparison, high dynamic range (HDR) images appear unnatural because they attempt to confine a large image range into a smaller display range through tone mapping, which is not how the image is naturally captured by a digital camera. Preferably, the method of the preferred embodiment preserves the natural range of the image by adjusting the range of the image to always fit around (either symmetrically or asymmetrically) the portion of the image viewable in the approximate center of the device's display. As noted above, the displayable scene of the method of the preferred embodiment is adjustable in response to any number of potential inputs relating to the orientation of the device and/or the nodal point. Accordingly, the method of the preferred embodiment can further include adjusting the floating point exposure of the displayable scene in response to any changes in the displayable scene, such as for example adjustments in the virtual zoom, virtual parallax, virtual perspective, and/or virtual origin described in detail above.

In another variation of the method of the preferred embodiment, the device can be a handheld device configured for processing both location-based and orientation-based data such as a smart phone, a tablet computer, or any other suitable device having integrated processing and display capabilities. Preferably, the handheld device can include an inertial measurement unit (IMU), which in turn can include one or more of an accelerometer, a gyroscope, a magnetometer, and/or a MEMS gyroscope. As noted above, the handheld device of the method of the preferred embodiment can also include one or more cameras oriented in one in or more distinct directions, i.e., front-facing and rear-facing, for determining one or more of the real orientation or the user orientation. Additional sensors of the handheld device of the method of the preferred embodiment can include a pedometer, a proximity sensor, an infrared sensor, an ultrasound sensor, and/or a global positioning transceiver. In another variation of the method of the preferred embodiment, the handheld device can be separate from a display, such as a handheld device configured to communicate both real orientation and user orientation to a stand-alone display such as a computer monitor or television.

### 5. Apparatus for Presenting a VAR Scene to a User

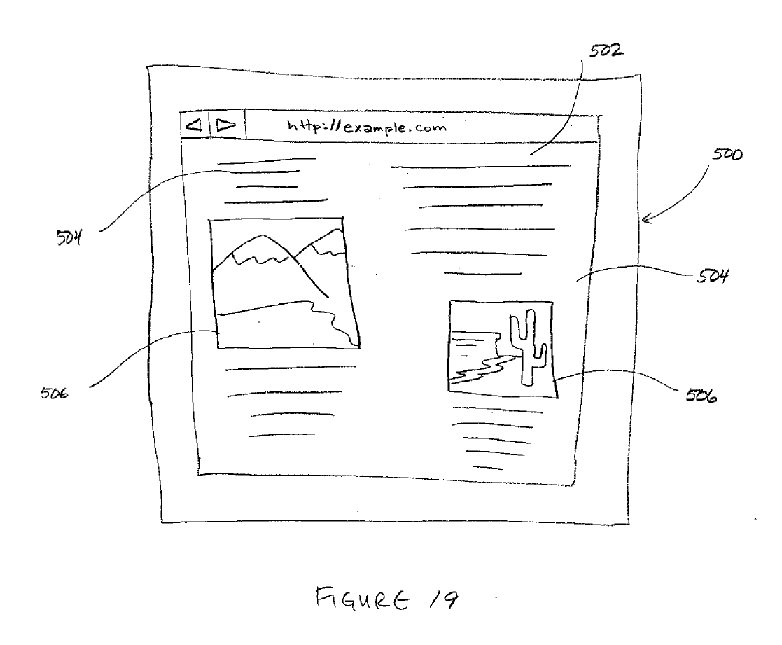

As shown in FIGS. 12 and 17, a device 10 of the preferred embodiment is usable in an operating environment 110 in which a user 112 interfacing with the device 114 at a predetermined distance 116. Preferably, the device 114 can include a user interface having a display 12 and a camera 90 substantially oriented in a first direction towards a user for viewing. The device 10 of the preferred embodiment can also include a real orientation module 16 configured to determine a three-dimensional spatial real orientation of the user interface relative to a projection matrix; and a user orientation module 16 configured to determine a user orientation of the user interface relative to a nodal point. The device 10 of the preferred embodiment can further include a processor 14 connected to the user interface, the real orientation module 16, and the user orientation module 16. Preferably, the processor 14 is configured to display a scene to the user 112 on the display 12 in response to the real orientation and the user orientation pursuant to one or more aspects of the method of the preferred embodiment described above.

As shown in FIG. 17, the device 10 of the preferred embodiment can include a display 12, an orientation module 16 including a real orientation module and a user orientation module, a location module 18, a camera 90 oriented in substantially the same direction as the display 12, and a processor 14 connected to each of the display, orientation module 16, location module 18, and camera 90. The device 10 of the preferred embodiment preferably functions to present a virtual and/or augmented reality (VAR) scene to a user from the point of view of a nodal point or center thereof, such that it appears to the user that he or she is viewing the world (represented by the VAR scene) through a frame of a window. The device 10 of the preferred embodiment can include any suitable type of mobile computing apparatus such as a smart phone, a personal computer, a laptop computer, a tablet computer, a television/monitor paired with a separate handheld orientation/location apparatus, or any suitable combination thereof.

As shown in FIG. 17, the orientation module 16 of the device 10 of the preferred embodiment includes at least a real orientation portion and a user orientation portion. The real orientation portion of the orientation module 16 preferably functions to provide a frame of reference for the device 10 as it relates to a world around it, wherein the world around can include real three dimensional space, a virtual reality space, an augmented reality space, or any suitable combination thereof. As noted above, the projection matrix can preferably include a mathematical representation of an arbitrary orientation of a three-dimensional object (i.e., device 10) having three degrees of freedom relative to a second frame of reference. As noted in the example above, the projection matrix can include a mathematical representation of the device 10 orientation in terms of its Euler angles (pitch, roll, yaw) in any suitable coordinate system.

In one variation of the device 10 of the preferred embodiment, the second frame of reference can include a three-dimensional external frame of reference (i.e., real space) in which the gravitational force defines baseline directionality for the relevant coordinate system against which the absolute orientation of the device 10 can be measured. In such an example implementation, the device 10 will have certain orientations corresponding to real world orientations, such as up and down, and further such that the device 10 can be rolled, pitched, and/or yawed within the external frame of reference. Preferably, the orientation module 16 can include a MEMS gyroscope configured to calculate and/or determine a projection matrix indicative of the orientation of the device 10. In one example configuration, the MEMS gyroscope can be integral with the orientation module 16. Alternatively, the MEMS gyroscope can be integrated into any other suitable portion of the device 10 or maintained as a discrete module of its own.

As shown in FIG. 17, the user orientation portion of the orientation module 16 preferably functions to provide a frame of reference for the device 10 relative to a point or object in space, including a point or object in real space. Preferably, the user orientation can include a measurement of a distance and/or rotational value/s of the device relative to a nodal point. In another variation of the device 10 of the preferred embodiment, the nodal point can include a user's head such that the user orientation includes a measurement of the relative distance and/or rotational value/s of the device 10 relative to a user's field of view. Alternatively, the nodal point can include a portion of the user's head, such as for example a point between the user's eyes. In another alternative, the nodal point can include any other suitable point in space, including for example any arbitrary point such as an inanimate object, a group of users, a landmark, a location, a waypoint, a predetermined coordinate, and the like. Preferably, as shown in FIG. 12, the user orientation portion of the orientation module 16 can function to create a viewing relationship between a user 112 (optionally located at the nodal point) and the device 10, such that a change in user orientation can cause a consummate change in viewable content consistent with the user's VAR interaction, i.e., such that the user's view through the frame will be adjusted consistent with the user's orientation relative to the frame.

As shown in FIG. 17, one variation of the device 10 of the preferred embodiment includes a location module 18 connected to the processor 14 and the orientation module 16. The location module 18 of the preferred embodiment functions to determine a location of the device 10. As noted above, location can refer to a geographic location, which can be indoors, outdoors, above ground, below ground, in the air or on board an aircraft or other vehicle. Preferably, as shown in FIG. 17, the device 10 of the preferred embodiment can be connectable, either through wired or wireless means, to one or more of a satellite positioning system 20, a local area network or wide area network such as a WiFi network 25, and/or a cellular communication network 30. A suitable satellite position system 20 can include for example the Global Positioning System (GPS) constellation of satellites, Galileo, GLONASS, or any other suitable territorial or national satellite positioning system. In one alternative embodiment, the location module 18 of the preferred embodiment can include a GPS transceiver, although any other type of transceiver for satellite-based location services can be employed in lieu of or in addition to a GPS transceiver.

The processor 14 of the device 10 of the preferred embodiment functions to manage the presentation of the VAR scene to the user 12. In particular, the processor 14 preferably functions to display a scene to the user on the display in response to the real orientation and the user orientation. The processor 14 of the preferred embodiment can be configured to process, compute, calculate, determine, and/or create a VAR scene that can be displayed on the device 10 to a user 112, wherein the VAR scene is oriented to mimic the effect of the user 112 viewing the VAR scene as if through the frame of the device 10. Preferably, orienting the scene can include preparing a VAR scene for display such that the viewable scene matches what the user would view in a real three-dimensional view, that is, such that the displayable scene provides a simulation of real viewable space to the user 112 as if the device 10 were a transparent frame. As noted above, the scene is preferably a VAR scene; therefore it can include one or more virtual and/or augmented reality elements composing, in addition to, and/or in lieu of one or more real elements (buildings, roads, landmarks, and the like, either real or fictitious). Alternatively, the scene can include processed or unprocessed images/videos/multimedia files of one or more displayable scene aspects, including both actual and fictitious elements as noted above.

As shown in FIG. 12, in another variation of the device 10 of the preferred embodiment, the scene can include a spherical image 120. Preferably, the portion of the spherical image (i.e., the scene 118) that is displayable by the device 10 corresponds to an overlap between a viewing frustum of the device (i.e., a viewing cone projected from the device) and the imaginary sphere that includes the spherical image 120. The scene 118 is preferably a portion of the spherical image 120, which can include a substantially rectangular display of a concave, convex, or hyperbolic rectangular portion of the sphere of the spherical image 120. Preferably, the nodal point is disposed at approximately the origin of the spherical image 120, such that a user 112 has the illusion of being located at the center of a larger sphere or bubble having the VAR scene displayed on its interior. Alternatively, the nodal point can be disposed at any other suitable vantage point within the spherical image 120 displayable by the device 10. In another alternative, the displayable scene can include a substantially planar and/or ribbon-like geometry from which the nodal point is distanced in a constant or variable fashion. Preferably, the display of the scene 118 can be performed within a 3D or 2D graphics platform such as OpenGL, WebGL, or Direct 3D. Alternatively, the display of the scene 118 can be performed within a browser environment using one or more of HTML5, CSS3, or any other suitable markup language. In another variation of the device 10 of the preferred embodiment, the geometry of the displayable scene can be altered and/or varied in response to an automated input and/or in response to a user input.

In another variation of the device 10 of the preferred embodiment, the real orientation portion of the orientation module 16 can be configured to create the projection matrix representing an orientation of the device 10 in a three-dimensional external frame of reference. As noted above, the projection matrix preferably includes a mathematical representation of an arbitrary orientation of a three-dimensional object such as the device 10 having three degrees of freedom relative to the external frame of reference. In one variation of the device 10 of the preferred embodiment, the external frame of reference can include a three-dimensional external frame of reference (i.e., real space) in which the gravitational force defines baseline directionality for the relevant coordinate system against which the absolute orientation of the device 10 can be measured. In one alternative noted above, the external frame of reference can include a fictitious external frame of reference, i.e., such as that encountered in a film or novel, whereby any suitable metrics and/or geometries can apply for navigating the device 10 through the pertinent orientations. One example of a fictitious external frame of reference noted above can include a fictitious space station frame of reference, wherein there is little to no gravitational force to provide the baseline directionality noted above. In such an example implementation, the external frame of reference can be fitted or configured consistently with the other features of the VAR scene.

In another variation of the device 10 of the preferred embodiment, the processor 14 can be further configured to adapt the scene displayable on the device 10 to the user 12 in response to a change in one of the real orientation or the user orientation. The processor 14 preferably functions to alter, change, reconfigure, recompute, regenerate, and/or adapt the displayable scene in response to a change in the real orientation or the user orientation in order to create a uniform and immersive user experience by adapting the displayable scene consistent with movement of the device 10 relative to the projection matrix and/or relative to the nodal point. Preferably, adapting the displayable scene can include at least one of the processor 14 adjusting a virtual zoom of the scene, the processor 14 adjusting a virtual parallax of the scene, the processor 14 adjusting a virtual perspective of the scene, and/or the processor 14 adjusting a virtual origin of the scene. Alternatively, adapting the displayable scene can include any suitable combination of the foregoing, performed by the processor 14 of the preferred embodiment substantially serially or substantially simultaneously, in response to a timing of any determined changes in one or both of the real orientation or the user orientation.

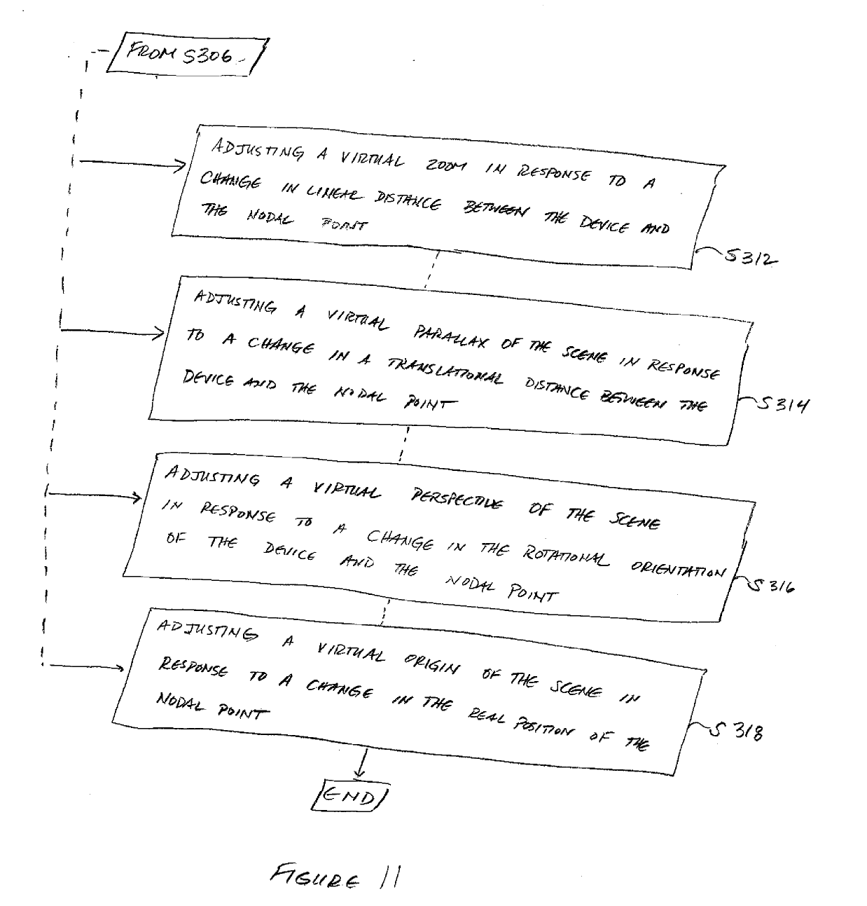

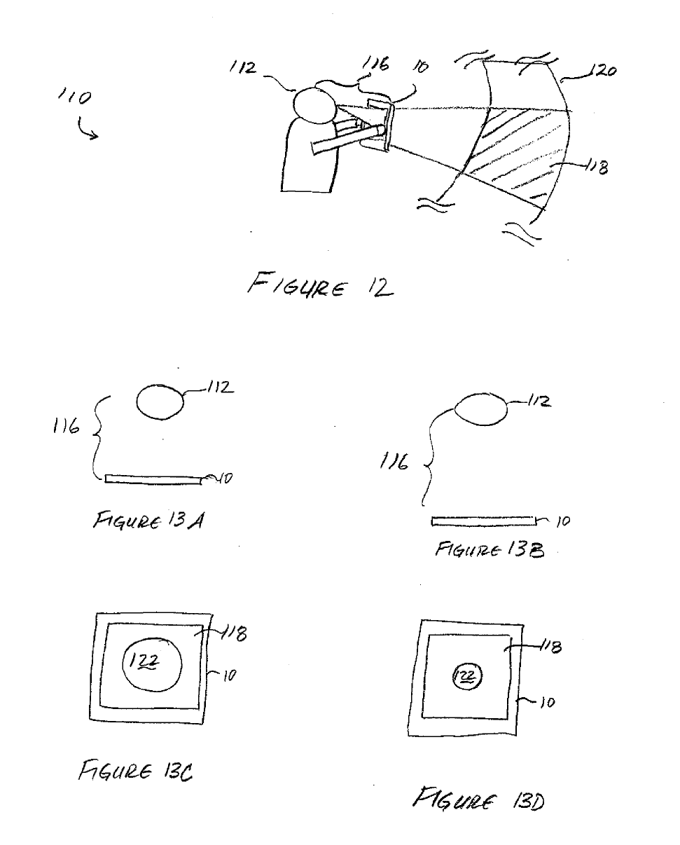

As shown in FIGS. 13A, 13B, 13C, and 13D, in one variation of the device 10 of the preferred embodiment, the processor is further configured to adjust a virtual zoom of the scene 118 in response to a change in a linear distance 116 between the device 10 and the nodal point 112. As shown in the FIGURES, the processor 114 of the preferred embodiment can be configured to alter a size of an aspect 122 of the scene 118 in response to an increase/decease in the linear distance 116 between the device 10 and the nodal point 112, i.e., the user's head. In another variation of the device 10 of the preferred embodiment, the device 10 can be configured to measure a distance 116 between the device 10 and the nodal point 112, which can include for example using a front facing camera 90 to measure the relative size of the nodal point 112 in order to calculate the distance 116. Alternatively, the adjustment of the virtual zoom can be proportional to a real zoom (i.e., a real relative sizing) of the nodal point 112 as captured by the device camera 90. As noted above, preferably as the distance decreases/increases, the size of the user's head will appear to increase/decrease, and the adjustment in the zoom can be linearly and/or non-linearly proportional to the resultant increase/decrease imaged by the camera 90. Alternatively, the distance 116 between the nodal point 112 and the device 10 can be measured and/or inferred from any other suitable sensor and/or metric, including at least those usable by the device 10 in determining the projection matrix as described above, including for example one or more cameras 90 (front/rear), an accelerometer, a gyroscope, a MEMS gyroscope, a magnetometer, a pedometer, a proximity sensor, an infrared sensor, an ultrasound sensor, and/or any module, portion, or component of the orientation module 16.

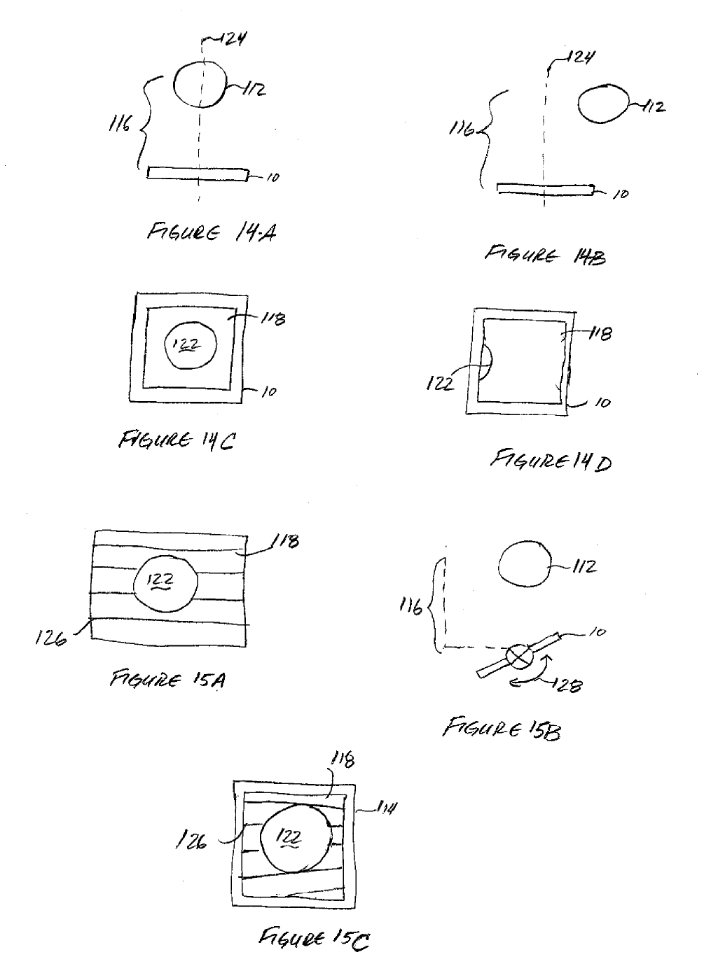

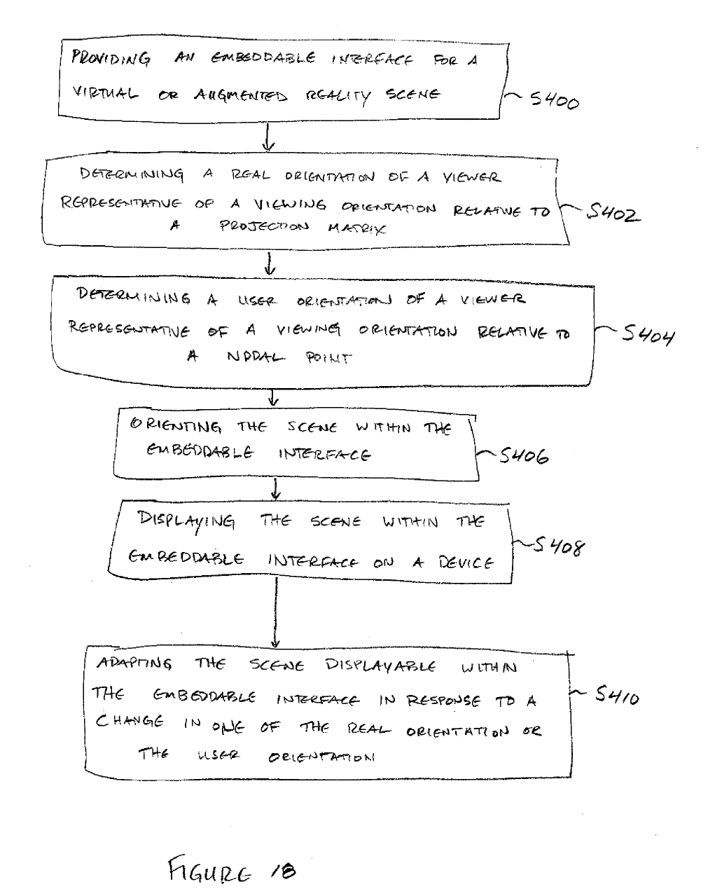

As shown in FIGS. 14A, 14B, 14C, and 14D, the processor 14 of the device of the preferred embodiment can be further configured to adjust a virtual parallax of the scene 118 in response to a change in a translational distance between the device 10 and the nodal point 112. As shown in FIG. 7B, movement of the device 10 relative to the nodal point 112 in a direction substantially perpendicular to imaginary line 124 can be interpreted by the processor 14 of the preferred embodiment as a request and/or input to move one or more aspects 122 of the scene 118 in a corresponding fashion. As shown in FIGS. 16A and 16B, the scene can include a foreground aspect 122 that is movable by the processor 14 relative to a background aspect 130. In another variation of the device 10 of the preferred embodiment, the processor 14 can be configured to identify one or more foreground aspects 122 and/or background aspects 130 of the displayable scene 118.

In another variation of the device 10 of the preferred embodiment, the processor 14 can be configured to measure a translational distance between the device 10 and the nodal point 112, which can include for example using a front facing camera 12 to measure the relative size and/or location of the nodal point 112 (i.e., the user's head) in order to calculate the translational distance. Alternatively, the translational distance between the nodal point 112 and the device 10 can be measured and/or inferred from any other suitable sensor and/or metric, including at least those usable by the device 10 in determining the projection matrix as described below, including for example one or more cameras 90 (front/rear), an accelerometer, a gyroscope, a MEMS gyroscope, a magnetometer, a pedometer, a proximity sensor, an infrared sensor, an ultrasound sensor, and/or any module, portion, or component of the orientation module 16.

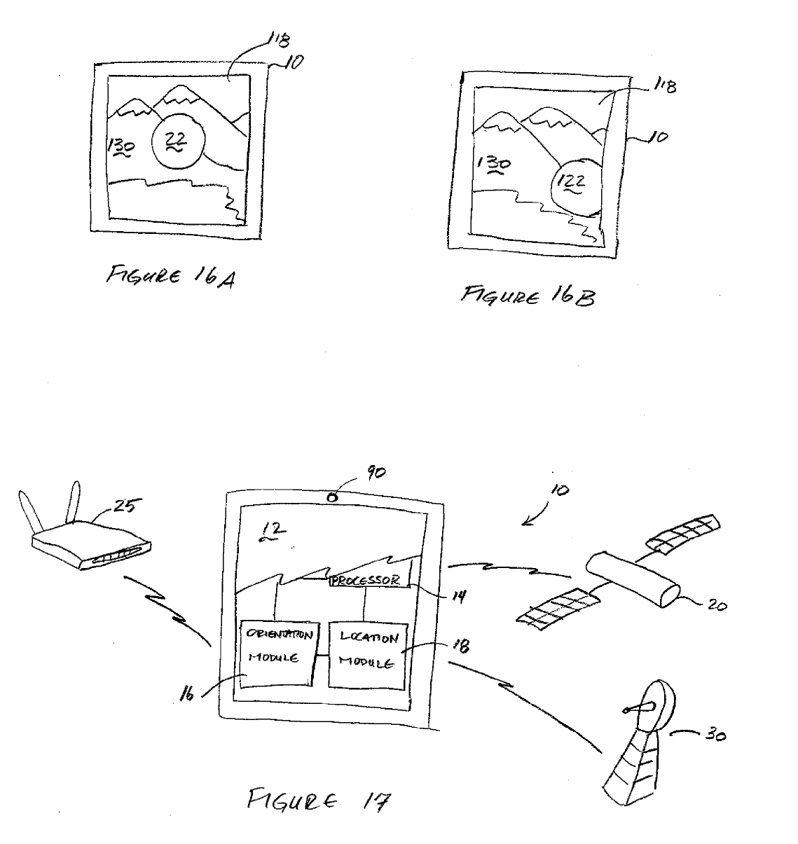

Preferably, the translational distance is computed by the processor 14 as a function of both the size of the nodal point 112 (from the front facing camera 90) and a detection of a planar translation of the device 10 in a direction substantially orthogonal to the direction of the camera 90, thus indicating a translational movement without any corrective rotation. For example, one or more of the aforementioned sensors can determine that the device 10 is moved in a direction substantially orthogonal to the camera direction 90 (along imaginary line 124 in FIGS. 14A and 14B), while also determining that there is no rotation of the device 10 about an axis (i.e., axis 128 shown in FIG. 15B) that would direct the camera 90 radially inwards towards the nodal point 112. Preferably, the processor 14 of the device 10 of the preferred embodiment can process the combination of signals indicative of such a movement as a translational shift of the device 10 relative to the nodal point 112 and adapt a virtual parallax of the viewable scene accordingly.

As shown in FIGS. 15A, 15B, and 15C, the processor 14 of the device 10 of the preferred embodiment can be further configured to adjust a virtual perspective of the scene 118 in response to a change in a rotational orientation of the device 10 and the nodal point 112. The processor 14 can preferably function to reorient, reshape, resize, and/or skew one or more aspects 122, 126 of the displayable scene 118 to convey a sense of perspective and/or a non-plan viewing angle of the scene 118 in response to a rotational movement of the device 10 relative to the nodal point 112. As noted above, adjustment of the virtual perspective of the scene is related in part to a distance between one end of the device and the nodal point and a distance between the other end of the device and the nodal point 112. As shown in FIG. 15B, rotation of the device 10 about axis 128 brings one side of the device 10 closer to the nodal point 112 than the other side, while leaving the top and bottom of the device 10 relatively equidistant from the nodal point 112.

As shown in FIG. 15C, preferred adjustment of aspects 122, 126 of the scene to create the virtual perspective will apply both to foreground aspects 122 and background aspects 126. The processor 14 of the preferred embodiment can adjust the virtual perspective of each aspect 122, 126 of the scene 118 in response to at least its position in the scene 118, the degree of rotation of the device 10 relative to the nodal point 112, the relative depth (foreground/background) of the aspect 122, 126, and/or any other suitable metric or visual cue. As noted above and as shown, lines that are parallel in the scene 118 when the device 10 is directed at the nodal point 112 shown in FIG. 15A will converge in some other direction in the display as shown in FIG. 15C as the device 10 is rotated as shown in FIG. 15B.

In another variation of the device 10 of the preferred embodiment, the processor 14 can be configured to reorient, reshape, resize, and/or translate one or more aspects of the displayable scene 118 in response to the detection of actual movement of the nodal point 112. As noted above, the nodal point 112 can include an arbitrary point in real or fictitious space relative to which the scenes 118 described herein are displayable. Accordingly, any movement of the real or fictitious nodal point 112 preferably results in a corresponding adjustment of the displayable scene 118 by the processor 14. In another variation of the device 10 of the preferred embodiment noted above, the nodal point 112 can include a user's head or any suitable portion thereof.

Preferably, one of more portions or modules of the orientation module 16 can detect movement of the nodal point 112 in real space, which movements can be used by the processor 14 creating the corresponding adjustments in the displayable scene 118. The real position of the nodal point 112 can preferably be determined using any suitable combination of devices, including for example one or more cameras (front/rear), an accelerometer, a gyroscope, a MEMS gyroscope, a magnetometer, a pedometer, a proximity sensor, an infrared sensor, an ultrasound sensor and/or any module, portion, or component of the orientation module 16. As an example, a user 112 can wear a pedometer in communication with the device such that when the user walks through real space, such movement of the user/nodal point 112 is translated into movement in the VAR space, resulting in a corresponding adjustment to the displayable scene 118. Alternatively, the location module 18 of the device 10 of the preferred embodiment can determine a position and/or motion of the device 10 in response to a global positioning signal associated with the device 10. Preferably, real and/or or simulated movement of the user/nodal point 112 in space can result in the adjustment of the location of the origin/center/viewing point of the displayable scene 118.

In another variation of the device 10 of the preferred embodiment, the processor 14 can be further configured to display a floating-point exposure of the displayable scene in order to minimize lighting irregularities. As noted above, the displayable scene 118 can be any suitable geometry, including for example a spherical image 120 disposed substantially symmetrically about a nodal point 112 as shown in FIG. 12. Displaying a floating-point exposure preferably functions to allow the user to view/experience the full dynamic range of the image without having to artificially adjust the dynamic range of the image. Preferably, the processor 14 of the preferred embodiment is configured to globally adjust the dynamic range of the image such that a portion of the image in the center of the display is within the dynamic range of the device. As noted above, comparable high dynamic range (HDR) images appear unnatural because they attempt to confine a large image range into a smaller display range through tone mapping, which is not how the image is naturally captured by a digital camera.

As shown in FIG. 12, preferably the processor 14 preserves the natural range of the image 120 by adjusting the range of the image 120 to always fit around (either symmetrically or asymmetrically) the portion of the image 118 viewable in the approximate center of the device's display 12. As noted above, the device 10 of the preferred embodiment can readily adjust one or more aspects of the displayable scene 118 in response to any number of potential inputs relating to the orientation of the device 10 and/or the nodal point 112. Accordingly, the device 10 of the preferred embodiment can further be configured to adjust a floating point exposure of the displayable scene 118 in response to any changes in the displayable scene 118, such as for example adjustments in the virtual zoom, virtual parallax, virtual perspective, and/or virtual origin described in detail above.

### 6. Method of Presenting an Embedded VAR Scene to a User

As shown in FIG. 18, another method of presenting a VAR scene to a user can include providing an embeddable interface for a virtual or augmented reality scene in block S400, determining a real orientation of a viewer representative of a viewing orientation relative to a projection matrix in block S402, and determining a user orientation of a viewer representative of a viewing orientation relative to a nodal point in block S404. The method of the preferred embodiment can further include orienting the scene within the embeddable interface in block S406 and displaying the scene within the embeddable interface on a device in block S408. The method of the preferred embodiment functions to present a virtual and/or augmented reality (VAR) scene to a user from the point of view of a nodal point or center thereof, such that it appears to the user that he or she is viewing the world (represented by the VAR scene) through a frame of a window. The method preferably further functions to enable the display of more content than is statically viewable within a defined frame. The method of the preferred embodiment can be performed at least in part by any number of selected devices having an embeddable interface, such as a web browser, including for example any mobile computing devices such as smart phones, personal computers, laptop computers, tablet computers, or any other device of the type described below.

As shown in FIG. 18, the method of the preferred embodiment can include block S400, which recites providing an embeddable interface for a VAR scene. Block S400 preferably functions to provide a browser-based mechanism for accessing, displaying, viewing, and/or interacting with VAR content. Block S400 can preferably further function to enable simple integration of interactive VAR content into a webpage without requiring the use of a standalone domain. Preferably, the embeddable interface can include a separate webpage embedded within a primary webpage using an IFRAME. Alternatively, the embeddable interface can include a flash projection element or a suitable DIV, SPAN, or other type of HTML tag. Preferably, the embeddable window can have a default setting in which it is active for orientation aware interactions from within the webpage. That is, a user can preferably view embeddable window without the user having to unlock or access the content, i.e., there is no need for the user to swipe a finger in order to see the content of the preferred embeddable window. Additionally or alternatively, the embeddable window can be receptive to user interaction (such as clicking or touching) that takes the user to a separate website that occupies the full frame of the browser, maximizes the frame approximately to cover the entire view of the screen, and/or pushes the VAR scene to an associated device.

As shown in FIG. 19, a preferred embeddable interface is sandboxed by nature such that a device 500 having a browser 504 can display one or more embedded windows 506 set within a larger parent webpage 502, each of which is accessible or actionable without affecting any other. Additionally, the sandboxed nature of the embeddable interface of the method of the preferred embodiment includes cross-domain constraints that lessen any security concerns. Preferably, one or more APIs that can be used to grant the webpage sandboxed access to one or more hardware components of the device 500, including for example the device camera, the device display, any device sensors such as an accelerometer, gyroscope, MEMS gyroscope, magnetometer, proximity sensor, altitude sensor, GPS transceiver, and the like. Access to the hardware aspects of the device 500 preferably can be performed by device API's or through any suitable API exposing device orientation information such as using HTML5. The method of the preferred embodiment includes affordances for viewing devices that have alternative capabilities. As will be described below, the form of interactions with the VAR scene can be selectively controlled based on the device 500 and the available sensing data for the device 500.

Additionally, block S400 of the preferred embodiment can include defining parameters for the default projection of each frame, either in the form of a projection matrix, orientation, skew or other projection parameters, supplied to each embedded window (i.e., frame). Alternatively, the parameters can be inferred from the placement of the embedded window in a parent page. Inter-frame frame communication can preferably be used to identify other frames and parameters of each frame. As an example, two separate embedded windows of the same scene on opposite sides of the screen can be configured with default orientations rotated a fixed amount from one another in order to emulate the effect of viewing a singular spatial scene through multiple, separate panes of a window as opposed to two windows into duplicate scenes.

As shown in FIG. 18, the method of the preferred embodiment can also include block S402, which recites determining a real orientation of a viewer representative of a viewing orientation relative to a projection matrix. Block S402 preferably functions to provide a frame of reference for the embeddable interface as it relates to a world around it, wherein the world around can include real three-dimensional space, a virtual reality space, an augmented reality space, or any suitable combination thereof. Block S402 preferably further functions to relate the orientation of the viewing device to displayable aspects or portions of the VAR scene. Preferably, the projection matrix can include a mathematical representation of an arbitrary orientation of a three-dimensional object having three degrees of freedom relative to a second frame of reference. As an example, the projection matrix can include a mathematical representation of a device's orientation in terms of its Euler angles (pitch, roll, yaw) in any suitable coordinate system. In one variation of the method of the preferred embodiment, the second frame of reference can include a three-dimensional external frame of reference (i.e., real space) in which the gravitational force defines baseline directionality for the relevant coordinate system against which the absolute orientation of the embeddable interface can be measured. Preferably, the real orientation of the embeddable interface can include an orientation of the viewing device (i.e., the viewer) relative to the second frame of reference, which as noted above can include a real three-dimensional frame of reference. In such an example implementation, the viewer will have certain orientations corresponding to real world orientations, such as up and down, and further such that the device (and the embeddable interface displayed thereon) can be rolled, pitched, and/or yawed within the external frame of reference. Alternatively, for a fixed viewing device, the projection matrix can function to determine the virtual orientation of the embeddable interface (which is not movable in real space) as it relates to the viewing orientation described above.

As shown in FIG. 18, the method of the preferred embodiment can further include block S404, which recites determining a user orientation of a viewing representative of a viewing orientation relative to a nodal point. Block S404 preferably functions to provide a frame of reference for the viewing device relative to a point or object in space, including a point or object in real space. Block S404 preferably further functions to provide a relationship between a nodal point (which can include a user as noted above) and the viewable content within the embeddable interface. Preferably, the user orientation can include a measurement of a distance and/or rotational value/s of the viewing device relative to the nodal point. In another variation of the method of the preferred embodiment, the nodal point can include a user's head such that the user orientation includes a measurement of the relative distance and/or rotational value/s of the device relative to a user's field of view. Alternatively, the nodal point can include a portion of the user's head, such as for example a point between the user's eyes. In another alternative, the nodal point can include any other suitable point in space, including for example any arbitrary point such as an inanimate object, a group of users, a landmark, a location, a waypoint, a predetermined coordinate, and the like. Preferably, the user orientation functions to create a viewing relationship between a user (optionally located at the nodal point) and the device, such that a change in user orientation can cause a consummate change in viewable content consistent with the user's VAR interaction, i.e., such that the user's view through the embeddable interface will be adjusted consistent with the user's orientation relative to the device. Alternatively, for a fixed viewing device, the user orientation can function to determine the virtual orientation of the embeddable interface (which is not movable in real space) and the nodal point (i.e., the user) as it relates to the viewing orientation described above.

As shown in FIG. 18, the method of the preferred embodiment can further include block S406, which recites orienting the scene within the embeddable interface. Block S406 preferably functions to process, compute, calculate, determine, and/or create a VAR scene that can be displayed on the device to a user through the embeddable interface, wherein the VAR scene is oriented to mimic the effect of the user viewing the VAR scene as if through the frame of the embeddable interface. Preferably, orienting the scene can include preparing a VAR scene for display such that the viewable scene matches what the user would view in a real three-dimensional view, that is, such that the displayable scene provides a simulation of real viewable space to the user as if the embeddable interface were a transparent frame being held up by the user. As noted above, the scene is preferably a VAR scene, therefore it can include one or more virtual and/or augmented reality elements composing, in addition to, and/or in lieu of one or more real elements (buildings, roads, landmarks, and the like, either real or fictitious). Alternatively, the scene can include processed or unprocessed images/videos/multimedia files of a multitude of scene aspects, including both actual and fictitious elements as noted above.

As shown in FIG. 18, the method of the preferred embodiment can further include block S408, which recites displaying the scene within the embeddable interface on a device. Block S408 preferably functions to render, present, project, image, and/or display viewable content on, in, or by a device having an embeddable interface. Preferably, the displayable scene can include a spherical image of a space having virtual and/or augmented reality components. In one variation of the method of the preferred embodiment, the spherical image displayable in the embeddable interface can be substantially symmetrically disposed about the nodal point, i.e. the nodal point is substantially coincident with and/or functions as an origin of a spheroid upon which the image is rendered. Alternatively, the displayable scene can include a six-sided cube having strong perspective, which can function as a suitable approximation of a spherical scene. In another alternative, the displayable scene can be composed of any number of images arranged in any convenient geometry such as a geodesic or other multisided polygonal solids.

Block S408 preferably further functions to display at least a portion of the VAR scene in the embeddable interface in response to the real orientation and the user orientation. Preferably, the device can include one or more orientation sensors (GPS, gyroscope, MEMS gyroscope, magnetometer, accelerometer, IMU) to determine a real orientation of the viewer relative to the projection matrix and at least a front-facing camera to determine a user orientation of the nodal point (i.e., user's head) relative to the viewer (i.e., mobile or fixed device). If the device is a handheld device, then preferably both the real orientation and the user orientation can be used in displaying the scene within the embeddable interface. Alternatively, if the device is a desktop or fixed device, then preferably the user orientation (position of the user's head relative to a front-facing camera) can be used in displaying the scene within the embeddable interface while a real orientation can be determined as being representative of a viewing orientation relative to the projection matrix as described above. In one alternative to the method of the preferred embodiment, if the device is a desktop or fixed device, then the real orientation and/or user orientation can be generated by the user performing one or more of a keystroke, a click, a verbal command, a touch, or a gesture.

As shown in FIG. 18, the method of the preferred embodiment can further include block S410, which recites adapting the scene displayable within the embeddable interface in response to a change in one of the real orientation or the user orientation. Block S410 preferably functions to alter, change, reconfigure, recompute, regenerate, and/or adapt the displayable scene in response to a change in the real orientation or the user orientation. Additionally, block S410 preferably functions to create a uniform and immersive user experience by adapting the displayable scene consistent with movement of the device relative to the projection matrix and/or relative to the nodal point. Preferably, adapting the displayable scene can include at least one of adjusting a virtual zoom of the scene, adjusting a virtual parallax of the scene, adjusting a virtual perspective of the scene, and/or adjusting a virtual origin of the scene. Alternatively, adapting the displayable scene can include any suitable combination of the foregoing, performed substantially serially or substantially simultaneously, in response to a timing of any determined changes in one or both of the real orientation or the user orientation.

Preferably, the device can access the real orientation and/or user orientation information through the embeddable interface. As an example, the device sensor information can preferably be accessed by embedding the window in an application with access to device sensor API's. For example, a native application can utilize JavaScript callbacks in a browser frame to pass sensor information to the browser. As another example, the browser can preferably have device API's pre-exposed that can be utilized by any webpage. In another example, HTML5 can preferably be used to access sensor information. For example, front facing camera display, accelerometer, gyroscope, and magnetometer data can be accessed through JavaScript or alternative methods.

The orientation data can be provided in any suitable format such as yaw, pitch, and roll, which can be converted to any suitable format for use in a perspective matrix described above. Once orientation data is collected and passed to the embedded window, the correct field of view is preferably rendered as an image in the embedded window. In one rendering variation, the embedded window preferably uses 3D CSS transforms available in HTML 5. The device orientation data is preferably collected (e.g., through a JavaScript callback or through exposed device API's) at a sufficiently high rate (e.g., 60 hz). The device orientation input can be used to continuously or regularly update a perspective matrix, which is in turn used to adjust the CSS properties according to the orientation input. In alternative rendering variations, OpenGL, WebGL, Direct 3D or any suitable 3D display can be used.

The method of the preferred embodiment can further include selecting an interaction mode for a viewing device, which functions to optimize the user control of the VAR scene based on the device viewing the embedded VAR scene window. As the embeddable VAR scene window is suitable for easy integration into an existing webpage, it can be presented to a wide variety of web-enabled devices. The type of device can preferably be detected through browser identification, testing for available methods, or any suitable means. The possible interactions are preferably scalable from rich immersive interaction to a limited minimum hardware interaction.

Some exemplary modes of operation are as follows. In a preferred mode of operation, there is an inertial measurement unit (IMU) and a front facing camera accessible on the device. The inertial measurement unit and possibly a GPS can be used for determining the real orientation. The front facing camera is preferably used to skew, rotate, or alter a field of view of the VAR scene based on the user orientation. In a second preferred mode, there is only an IMU accessible on the device. The IMU is used to alter the VAR scene based solely in response to the real orientation. In a third preferred mode, there is only a front facing camera (such as on a desktop computer or a laptop computer). The front facing camera can be used to skew, rotate, or alter a field of view of the VAR scene based on viewing distance/position represented by the user orientation. To compensate for a lack of orientation information, the third preferred mode of operation can employ nodal point tracking heuristics. For example, the field of view of the VAR scene can shift in response to movement of the user as detected by the front-facing camera. In fourth preferred mode, there may only be a keyboard, mouse or touch input. Any of these inputs can be adapted for any suitable navigation of the VAR scene such as using mouse clicks and drags to alter orientation of a field of view of a VAR scene.

The apparatuses and methods of the preferred embodiment can be embodied and/or implemented at least in part as a machine configured to receive a computer-readable medium storing computer-readable instructions. The instructions are preferably executed by computer-executable components preferably integrated with the user interface 12 and one or more portions of the processor 14, orientation module 16 and/or location module 18. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention defined in the following claims.

What is claimed is:

1. A method of presenting a scene to a user comprising:
providing an embeddable interface for a virtual or augmented reality scene;
determining a real orientation of a viewer representative of a viewing orientation relative to a projection matrix;
determining a user orientation of a viewer representative of a viewing orientation relative to a nodal point;
orienting the scene within the embeddable interface; and
displaying the scene within the embeddable interface on a device.

2. The method of claim 1, wherein the embeddable interface comprises a window within a web browser.

3. The method of claim 1, wherein the embeddable interface comprises an iframe disposed within a webpage.

4. The method of claim 1, wherein the device comprises a mobile handheld device.

5. The method of claim 1, wherein the device comprises a desktop computing device.

6. The method of claim 1, further comprising adapting the scene displayable within the embeddable interface in response to a change in one of the real orientation or the user orientation.

7. The method of claim 6, wherein a change in one of the real orientation or the user orientation comprises a change detectable by the device.

8. The method of claim 7, wherein the device comprises a mobile handheld device, and wherein the change detectable by the device comprises a change in a device orientation.

9. The method of claim 8, wherein the device orientation comprises an orientation of the device in a three-dimensional external frame of reference determined by the projection matrix.

10. The method of claim 7, wherein the device comprises a desktop computing device, and wherein the change detectable by the device comprises a user input.

11. The method of claim 10, wherein the user input comprises one of: a keystroke, a click, a verbal command, a touch, or a gesture.
